(19) United States
(12) Patent Application Publication
(10) Pub. No.: US 2018/0147577 A1
(43) Pub. Date: May 31, 2018

(54) TIP RACK, SAMPLE PROCESSING APPARATUS, RACK BODY, AND METHOD OF ATTACHING NOZZLE TIP

(71) Applicant: SYSMEX CORPORATION, Kobe-shi (JP)

(72) Inventor: Ryutaro SHINYA, Kobe-shi (JP)

(73) Assignee: SYSMEX CORPORATION, Kobe-shi (JP)

(21) Appl. No.: 15/821,936

(22) Filed: Nov. 24, 2017

(30) Foreign Application Priority Data
Nov. 30, 2016 (JP) 2016-233708

(51) Int. Cl. B01L 9/00; G01N 35/10

(52) U.S. Cl. CPC B01L 9/543; B05B 15/061; G01N 2035/103; G01N 35/10; B01L 2200/025; B05B 15/065

(57) ABSTRACT

An embodiment may provide a tip rack for detachably supporting a nozzle tip to be attached to a distal end portion of a nozzle. The tip rack includes: a support member that is provided with first holes each to support the nozzle tip; and a rack body that supports the support member such that the support member is movable in a direction intersecting with center axes of the first holes, and that is provided with second holes corresponding to the first holes, the second holes each having a depth enough to accommodate a lower portion of the nozzle tip, including a distal end of the nozzle tip, supported by the corresponding first hole.

### CROSS REFERENCE TO RELATED APPLICATIONS

This application claims priority from prior Japanese Patent Applications No. 2016-233708, filed on Nov. 30, 2016, the entire contents of which are incorporated herein by reference.

### BACKGROUND

The disclosure relates to a tip rack, a sample processing apparatus, a rack body, and a method of attaching a nozzle tip.

### BACKGROUND ART

There is known an apparatus in which nozzle tips supported by a tip rack are attached to nozzle distal ends in an operation of sucking samples. For example, Patent Literature 1 (Japanese Patent Application Publication No. Hei 8-94637) describes transporting a tip rack 910 to a tip attaching position 903 with a side wall portion 911 of the tip rack 910 sliding along a side wall surface 920 for positioning as illustrated in FIG. 21, in order to position nozzle tips supported by the tip rack relative to nozzles.

Positioning of the tip rack 910 is performed as follows. The tip rack 910 set at a rack setting position 901 is transported to a rack setting position 902 by a rack pressing and transporting member 930. The rack pressing and transporting member 930 is attached to a belt 953 stretched between belt wheels 951 and 952 which are directly connected to a non-illustrated motor and rotationally driven by the motor. Thus, the rack pressing and transporting member 930 moves in the front-rear direction in accordance with the movement of the belt 953. With the movement of the rack pressing and transporting member 930, a side wall portion 912 on the rear side of the tip rack 910 is pushed, and the side wall portion 911 on the front side of the tip rack 910 comes into contact with a side wall surface 920. This positions the tip rack 910 at the rack setting position 902.

Then, the tip rack 910 positioned at the rack setting position 902 is transported to the tip attaching position 903 by a rack grasping and transporting member 940. The rack grasping and transporting member 940 includes a first member 941 and a second member 942. The first member 941 and the second member 942 clamp a side wall portion 913 on the right side of the tip rack 910 positioned at the rack setting position 902. In this state, the tip rack 910 at the rack setting position 902 is transported to the tip attaching position 903.

When the tip rack 910 is properly positioned at the tip attaching position 903 as described above, nozzle tips 914 accommodated in the tip rack 910 are properly positioned to the positions right below the nozzles. As a result, the nozzle tips 914 can be properly attached to the nozzles.

### SUMMARY

However, the apparatus in Patent Literature 1 needs the rack pressing and transporting member 930, the rack grasping and transporting member 940, and a mechanism for transporting these members as described above to bring the tip rack 910 into contact with the side wall surface 920 for positioning. For this reason, the configuration for positioning the nozzle tips accommodated in the tip rack 910 relative to the nozzles is complicated.

In addition, formation of the tip rack may cause formation errors of the tip rack in some cases. In this case, even if the tip rack is positioned with high accuracy, the positions of the nozzle tips accommodated in the tip rack are offset from the positions right below the nozzles. As a result, there is a possibility that the nozzle tips cannot be properly attached to the nozzles.

An embodiment provides a tip rack, a sample processing apparatus, a rack body, and a method of attaching a nozzle tip, with which nozzle tips can be properly attached to nozzles with a simple configuration.

A first aspect of the disclosure relates to a tip rack for detachably supporting a nozzle tip to be attached to a distal end portion of a nozzle. The tip rack according to the first aspect includes: a support member that is provided with first holes each to support the nozzle tip; and a rack body that supports the support member such that the support member is movable in a direction intersecting with center axes of the first holes, and that is provided with second holes corresponding to the first holes, the second holes each has a depth enough to accommodate a lower portion of the nozzle tip supported by the corresponding first hole, the lower portion including a distal end of the nozzle tip.

According to the first aspect, the support member is movable in a direction intersecting with the center axes of the first holes. Hence, even if a positional offset occurs between a nozzle tip supported by the first hole and the nozzle to which this nozzle tip is to be attached, the nozzle tip moves together with the support member along with insertion of the nozzle into the nozzle tip, and the nozzle tip is positioned at the center of the nozzle. With this movement, the nozzle tip is properly attached to the nozzle. In addition, since the entire tip rack is not moved to position the nozzle tip to the center of the nozzle, but only the support member, which is lighter than the rack body, is moved to make a positional adjustment, the nozzle tip can easily be positioned at the center of the nozzle by inserting the nozzle to the nozzle tip.

In the first aspect, the support member may be attachable to and detachable from the rack body.

In the first aspect, the rack body may include a restriction portion that faces an outer periphery of the support member with a specified clearance, and that allows the support member to move within the clearance in the direction intersecting with the center axes of the first holes.

In the first aspect, a movement range of the support member may be set larger than or equal to a difference between a diameter of an opening at an upper end of the nozzle tip and a maximum width of the distal end portion of the nozzle to be inserted into the opening. With this setting, even if the nozzle distal end portion is within the area of the opening, at least the center axes of the nozzle and the nozzle tip can be made coincident.

In the first aspect, a diameter of each of the second holes may be set such that a side surface of the nozzle tip supported by the corresponding first hole does not touch an inner side surface of the second hole when the support member moves in a movement range of the support member relative to the rack body. With this setting, even if the nozzle tip moves in a direction intersecting with the center axes of the first holes along with movement of the support member, the side surface of the nozzle tip does not incline by touching the inner side surface of the second hole. Hence, the nozzle tip can be properly attached to the nozzle.

In the first aspect, a wall in a lattice shape with a constant height may be formed on a lower surface of the support member, and a lower end of the wall may be placed on a support surface of the rack body. With this configuration, the distance between the first holes and the second holes can be increased by the wall. Hence, when the tapered nozzle tip is supported by the first hole, the width of the nozzle tip at the position of the second hole is much smaller than the width of the nozzle tip at the position of the first hole. With this configuration, when the nozzle tip moves in a direction intersecting with the center axes of the first holes along with the movement of the support member, it is possible to prevent the nozzle tip from being inclined by the side surface of the nozzle tip touching the inner side surface of the second hole. In addition, providing the wall in a lattice shape makes the support member light and keeps the strength of the support member high. As a result, it is possible to move the support member smoothly within the range allowed by the clearance, as well as make the support member strong enough to withstand the force exerted when inserting the nozzles into the nozzle tips. In addition, since the contact area between the support member and the support surface can be small, it is possible to move the support member smoothly.

In this case, the wall may be formed such that areas surrounded by the wall are arrayed in a matrix shape, and the first hole is formed in each of the areas. With this configuration, multiple nozzle tips can be supported by the tip rack. In addition, since the first holes are aligned, the nozzle tips supported by the first holes in each row can be attached to the nozzles at one time.

In the first aspect, the first holes may be formed in the support member to be arrayed in a matrix shape. With this configuration, the nozzle tips supported by the first holes in each row can be attached to the nozzles at one time.

In the first aspect, the tip rack may include a contact portion that contacts the support member to restrict movement of the support member such that the support member does not get apart from the rack body in a direction parallel to the center axes of the first holes. With this configuration, even if a nozzle tip is not easily pulled out of the first hole, it is possible to prevent the support member from being raised together with the nozzle tip along with the upward movement of the nozzle after the nozzle tip is attached.

In this case, the contact portion may be a protrusion protruding from the rack body toward the support member. With this, the contact portion can be configured in a simple manner and at a low cost.

In the first aspect, the rack body may include a base provided with the second holes, and the base excluding the second holes may be fully made of a material of the rack body. This makes it possible to increase the weight of the rack body. As a result, even if the nozzle tip is not easily pulled out of the first hole, it is possible to prevent the rack body from being raised together with the nozzle tip along with the upward movement of the nozzle after the nozzle tip is attached.

In this case, a specific gravity of the material of the rack body may be larger than a specific gravity of the support member. With this configuration, it is possible to positively prevent the rack body from being raised together with the nozzle tip.

In the first aspect, the support member may include a temporary fixing portion to temporarily fix a second support member to an upper surface of the support member in the case where the support member supports the nozzle tip supported by the second support member. This configuration makes it possible to let the support member support the nozzle tip together with the second support member.

In the first aspect, a diameter of the second holes may be set smaller than or equal to a diameter of the first holes. With this configuration, even if the nozzle tip inclines from the center axis of the first hole, the distal end of the nozzle tip touching the inner side surface of the second hole prevents the nozzle tip from inclining when supported by the support member. Hence, the nozzle tips can be properly attached to the nozzles.

In the first aspect, an outer peripheral surface of the rack body may be provided with a depression depressed inward of the rack body. With this configuration, when the tip rack is set to an apparatus with the tip rack fitted in a frame on the apparatus side, the area where the depression is provided does not contact the frame. This reduces friction force generated between the tip rack and the frame. Thus, the tip rack can be smoothly fitted into the frame smoothly. In addition, an operator can easily set the tip rack to the apparatus by hooking fingers to the depressions to grasp the tip rack.

In the first aspect, an outer peripheral surface of the rack body may be provided with an inclined surface extending gradually outward of the rack body while extending upward. With this configuration, when the tip rack is set in the apparatus with the tip rack fitted in the opening of a frame on the apparatus side, the tip rack can be positioned at the center of the frame, being guided by the inclined surface. Hence, the tip rack can be fitted into the frame smoothly.

A second aspect of the disclosure relates to a tip rack for supporting a nozzle tip to be attached to a distal end portion of a nozzle. The tip rack according to the second aspect includes: a support member that is provided with a hole to support the nozzle tip; and a rack body that supports the support member such that the support member is movable in a direction intersecting with a center axis of the hole. Here, a movement range of the support member relative to the rack body is set larger than or equal to a difference between a diameter of an opening at an upper end of the nozzle tip and a maximum width of the distal end portion of the nozzle to be inserted into the opening.

According to the second aspect, the same effects as in the first aspect can be obtained. Specifically, the support member is movable in the direction intersecting with the center axis of the first hole. Hence, when a positional offset occurs between the nozzle tip supported by the hole and the nozzle to which this nozzle tip is to be attached, the nozzle tip moves together with the support member along with insertion of the nozzle into the nozzle tip, and the nozzle tip is positioned at the center of the nozzle. With this movement, the nozzle tip is properly attached to the nozzle. In addition, even if the nozzle distal end portion is within the area of the opening, at least the center axes of the nozzle and the nozzle tip can be made coincident.

In the second aspect, the rack body may include a restriction portion that faces an outer periphery of the support member with a clearance, and that allows the support member to move within the clearance in the direction intersecting with the center axis of the hole.

In the second aspect, the tip rack may include a contact portion that contacts the support member to restrict movement of the support member such that the support member does not get apart from the rack body in a direction parallel to the center axis of the hole.

In the second aspect, the movement range of the support member may be set smaller than or equal to a difference between the diameter of the opening at the upper end of the nozzle tip and a minimum width of the distal end portion of the nozzle to be inserted into the opening. With this setting, even when the support member is positioned at the limit position of the movement range, the nozzle distal end portion does not touch the outer edge of the opening of the nozzle tip, and the nozzle distal end portion is properly inserted into the opening. Accordingly, the nozzle tips can be properly attached to the nozzles.

A third aspect of the disclosure relates to a sample processing apparatus. A sample processing apparatus according to the third aspect includes: the tip rack according to the first or second aspect; a frame into which the rack body is fitted; and a nozzle to which the nozzle tip is attached, in which the sample processing apparatus processes a sample using the nozzle tip attached to the nozzle.

According to the third aspect, the same effects as in the first or second aspect can be obtained. Hence, samples can be properly processed.

A fourth aspect of the disclosure relates to a rack body for supporting a support member provided with first holes each to detachably support a nozzle tip to be attached to a distal end portion of a nozzle. The rack body according to the fourth aspect supports the support member such that the support member is movable in a direction intersecting with center axes of the first holes, and has second holes corresponding to the first holes on a one-to-one basis, the second holes each having a depth enough to accommodate a lower portion of the nozzle tip supported by the corresponding first hole, the lower portion including a distal end of the nozzle tip.

According to the fourth aspect, the same effects as in the first or second aspect can be obtained because the support member is supported by the rack body. Hence, samples can be properly processed.

A fifth aspect of the disclosure relates to a method of attaching a nozzle tip. A method of attaching a nozzle tip according to the fifth aspect includes: moving a nozzle to above a rack body that supports a support member with a first hole to support the nozzle tip such that the support member is movable in a direction intersecting with a center axis of the first hole; inserting the nozzle into an opening at an upper end of the nozzle tip supported by the first hole, by moving down the nozzle to the support member supported by the rack body; and attaching the nozzle tip to the nozzle by further inserting the nozzle into the nozzle tip which is adjusted in position by movement of the support member in the direction intersecting with the center axis of the first hole.

According to the fifth aspect, the same effects as in the first or second aspect can be obtained.

In the fifth aspect, a movement range of the support member may be set larger than or equal to a difference between a diameter of the opening at the upper end of the nozzle tip and a maximum width of a distal end portion of the nozzle to be inserted into the opening.

In the fifth aspect, a movement range of the support member may be set smaller than or equal to a difference between a diameter of the opening at the upper end of the nozzle tip and a minimum width of a distal end portion of the nozzle to be inserted into the opening.

In the fifth aspect, the rack body has second holes at positions corresponding to the first holes on a one-to-one basis, and each of the second holes has a depth enough to accommodate a lower portion of the nozzle tip including a distal end thereof, the nozzle tip supported by the corresponding first hole.

The above aspects make it possible to properly attach the nozzle tips to the nozzles with a simple configuration.

### BRIEF DESCRIPTION OF DRAWINGS

FIG. 1A is a schematic diagram illustrating a cross section of a tip rack according to Embodiment 1 before assembly, taken along a plane parallel to the XZ plane, when viewed in the Y axis positive direction; FIG. 1B is a schematic diagram illustrating the cross section of the tip rack according to Embodiment 1 after assembly, taken along a plane parallel to the XZ plane, when viewed in the Y axis positive direction;

FIGS. 2A and 2B are schematic diagrams for explaining attaching a nozzle tip to a nozzle according to Embodiment 1;

FIGS. 3A and 3B are schematic diagrams for explaining attaching a nozzle tip to a nozzle according to Embodiment 1;

FIG. 4 is a perspective view illustrating configuration of a tip rack and nozzle tips supported by a second support member before assembly, according to Embodiment 1;

FIG. 5A is a plan view of the lower surface of a support member according to Embodiment 1, when viewed in the Z axis negative direction; FIG. 5B is a perspective view of a rack body according to Embodiment 1, when viewed from the lower side;

FIG. 6A is a diagram of a cross section of the tip rack supporting the nozzle tip according to Embodiment 1, taken along a plane parallel to the YZ plane, when viewed in the X axis positive direction; FIG. 6B is a diagram of a cross section of the tip rack supporting the nozzle tip according to Embodiment 1, taken along a plane parallel to the XZ plane, when viewed in the Y axis positive direction;

FIG. 7 is a schematic diagram of the inside of the housing of a sample processing apparatus according to Embodiment 1, when viewed from above;

FIG. 8 is a diagram illustrating tip racks placed in tip rack placement sections according to Embodiment 1;

FIG. 9A is a diagram illustrating a microplate to be placed in a microplate placement section and a reagent container to be placed in a reagent container placement section, according to Embodiment 1; FIG. 9B is a diagram illustrating reagent containers placed in reagent container placement sections, according to Embodiment 1;

FIGS. 10A and 10B are diagrams illustrating the microplate placed in the microplate placement section and the reagent container placed in the reagent container placement section, according to Embodiment 1;

FIG. 11 is a perspective view illustrating configurations of a second drive mechanism and a suction and discharge unit, according to Embodiment 1;

FIG. 12A is a diagram of a lift bar and a suction and discharge unit according to Embodiment 1 when viewed from the front; FIG. 12B is a diagram illustrating a state where nozzle tips are attached to nozzles according to Embodiment 1;

FIG. 13A is a diagram illustrating that sucking is performed when the lift bar according to Embodiment 1 moves up; FIG. 13B is a diagram illustrating that the nozzle tips according to Embodiment 1 are dropped from the nozzles;

FIG. 14A is a perspective view illustrating a configuration of the nozzle according to Embodiment 1; FIG. 14B is a view of the nozzle according to Embodiment 1 when viewed from below;

FIG. 15 is a block diagram illustrating a configuration of the sample processing apparatus according to Embodiment 1;

FIG. 16 is a flowchart illustrating a procedure of a gene test according to the BEAMing method using the sample processing apparatus according to Embodiment 1;

FIG. 17 is a diagram schematically illustrating states of the course of the gene test according to Embodiment 1;

FIG. 18A is a plan view of a rack body according to Embodiment 2 when viewed in the Z axis positive direction; FIG. 18B is a plan view of the lower surface of a support member according to Embodiment 2 when viewed in the Z axis negative direction;

FIG. 19A is a plan view of a rack body according to Embodiment 3 when viewed in the Z axis positive direction; FIG. 19B is a plan view of a rack body according to a modification of Embodiment 3 when viewed in the Z axis positive direction;

FIG. 20A is a plan view of a rack body according to Embodiment 4 when viewed in the Z axis positive direction; FIG. 20B is a plan view of a rack body according to a modification of Embodiment 4 when viewed in the Z axis positive direction; and

FIG. 21 is a schematic diagram for explaining a configuration according to a related art.

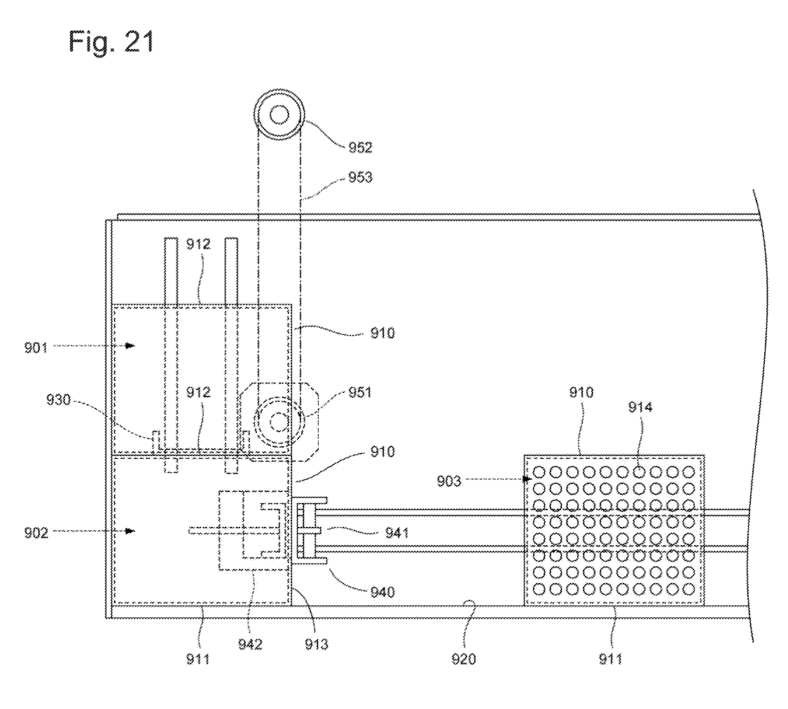

### DETAILED DESCRIPTION

Embodiments are explained with reference to drawings. In the respective drawings referenced herein, the same constituents are designated by the same reference numerals and duplicate explanation concerning the same constituents is basically omitted. All of the drawings are provided to illustrate the respective examples only. No dimensional proportions in the drawings shall impose a restriction on one or more embodiments. For this reason, specific dimensions and the like should be interpreted with the following descriptions taken into consideration. In addition, the drawings may include parts whose dimensional relationship and ratios are different from one drawing to another.

### Embodiment 1

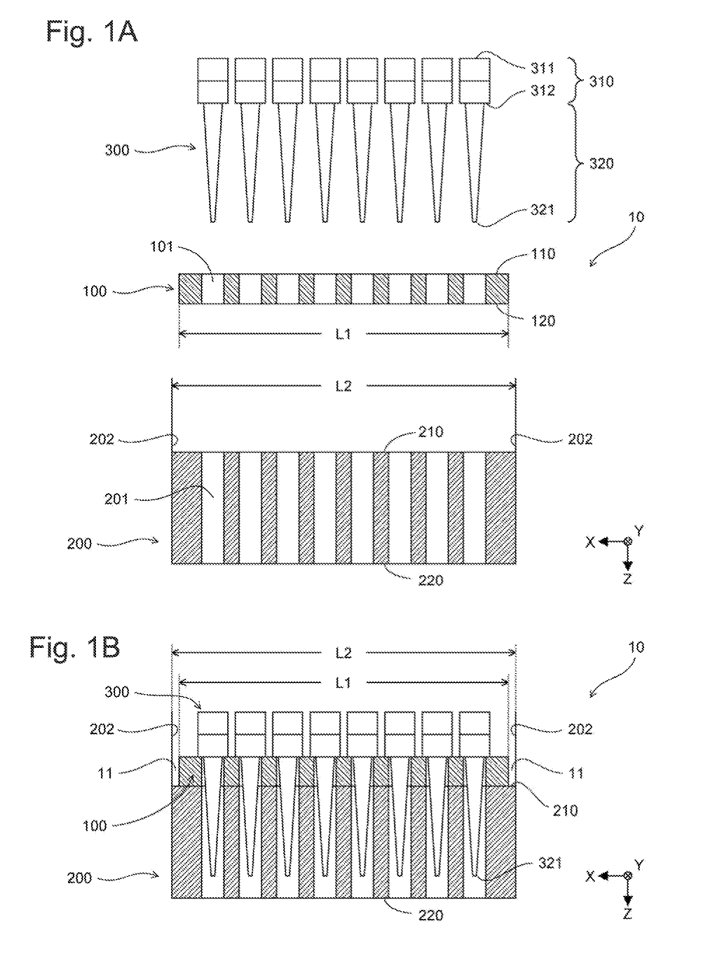

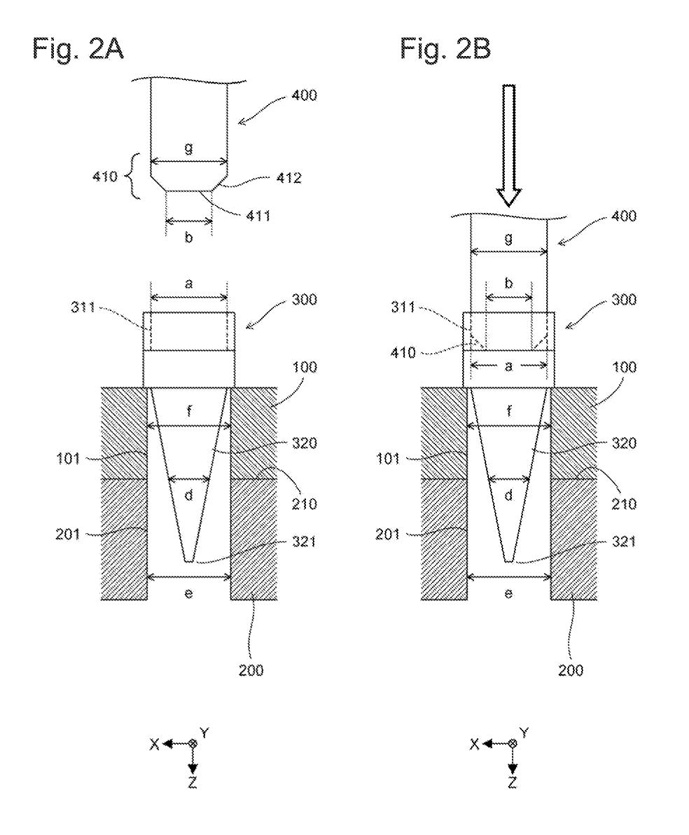

As illustrated in FIGS. 1A and 1B, a tip rack 10 includes a support member 100 and a rack body 200. The tip rack 10 attachably and detachably supports nozzle tips 300 adapted to be attached to distal end portions 410 of nozzles 400, which are to be described later with reference to FIG. 2A. FIGS. 1A and 1B are schematic diagrams illustrating a cross section of the tip rack 10 taken along a plane parallel to the XZ plane when viewed in the Y axis positive direction. In FIGS. 1A and 1B, the X, Y, and Z axes are orthogonal to each other. The X axis positive direction indicates the left direction, the Y axis positive direction indicates the rear direction, and the Z axis positive direction indicates the vertically downward direction. Also in the following drawings, the XYZ axes are the same as those indicated in FIGS. 1A and 1B.

As illustrated in FIG. 1A, the nozzle tip 300 includes an upper portion 310 and a lower portion 320. The upper portion 310 includes an opening 311 opened upward and a stepped portion 312 located at the lower end of the upper portion 310. Into the opening 311, the distal end portion 410 of the nozzle 400 illustrated in FIG. 2A is inserted from the above. The stepped portion 312 includes a surface parallel to the XY plane. The diameter of the outer circumferential portion of the stepped portion 312 is larger than that of the upper end of the lower portion 320. The lower portion 320 has a tapered shape which decreases in diameter while extending in the Z axis positive direction. At a distal end 321 located at the lower end of the lower portion 320 is formed a hole connecting the inside and the outside of the nozzle tip 300. At the use of the nozzle tip 300, the nozzle 400 is attached to the opening 311, and the nozzle 400 applies a pressure inside the nozzle tip 300. With this operation, liquid is sucked from the distal end 321, and liquid is discharged from the distal end 321.

The support member 100, a plate member parallel to the XY plane, supports the nozzle tips 300. The support member 100 includes first holes 101 aligned in the X axis direction. The first holes 101 pass through the support member 100 in the up-down direction. An upper surface 110 and a lower surface 120 of the support member 100 are surfaces parallel to the XY plane. The lower portion 320 of the nozzle tip 300 is passed through the first hole 101, and the stepped portion 312 of the nozzle tip 300 is supported by the upper surface 110 around the first hole 101, so that the nozzle tip 300 is supported by the first hole 101. The length of the outer peripheral portion of the support member 100 in the X axis direction is L1.

The rack body 200 includes second holes 201 aligned in the X axis direction and restriction portions 202. The second holes 201 are provided to correspond to the respective first holes 101 of the support member 100. In other words, the second holes 201 are arranged such that when the support member 100 is placed on an upper surface 210 of the rack body 200, the first holes 101 are positioned at the same places of the second holes 201. The support member 100 is provided with the first holes 101 and the rack body 200 is provided with the second holes 201, and thus the nozzle tips 300 can be supported by the tip rack 10.

The second hole 201 is deep enough to accommodate the lower portion 320 of the nozzle tip 300 supported by the first hole 101, down to the distal end 321 of the nozzle tip 300. The second holes 201 pass through the rack body 200 in the up-down direction. The upper surface 210 and a lower surface 220 of the rack body 200 are surfaces parallel to the XY plane. Note that the second hole 201 only needs to accommodate the nozzle tip 300 from the upper side to the distal end 321. Hence, the lower end of the second hole 201 does not need to reach the lower surface 220.

The restriction portions 202, a pair of plate-like members parallel to the YZ plane, are formed to extend upward from the upper surface 210. The restriction portion 202 on the X axis positive side is provided at the end on the X axis positive side of the upper surface 210, and the restriction portion 202 on the X axis negative side is provided at the end on the X axis negative side of the upper surface 210. The distance between the inner surfaces of the two restriction portions 202 is L2, which is larger than L1. Note that the restriction portions 202 do not necessarily need to be formed integrally with the rack body 200, but may be made with another member attached to the rack body 200.

As illustrated in FIG. 1B, when the support member 100 is placed on the upper surface 210 of the rack body 200, the tip rack 10 is completed. As described above, the support member 100 is attachable to and detachable from the rack body 200. Here, when the first holes 101 and the second holes 201 are positioned at the same places, clearances 11 occur between the restriction portion 202 on the X axis positive side and the end on the X axis positive side of the support member 100 as well as between the restriction portion 202 on the X axis negative side and the end on the X axis negative side of the support member 100. Hence, the support member 100 is movable within the range of the clearance 11 in a direction orthogonal to the center axes of the first holes 101, specifically, in the X axis direction. In other words, the restriction portions 202 face the periphery of the support member 100 placed on the rack body 200 with the clearances 11 in between and allow the support member 100 to move within the range of the clearance 11 in the X axis direction.

Then, the nozzle tips 300 are placed on the tip rack 10 of FIG. 1B. Specifically, the nozzle tips 300 are each placed to the combinations of the first hole 101 and the second hole 201 aligned vertically. After that, the distal end portion 410 of the nozzle 400 illustrated in FIG. 2A is inserted into the opening 311 of the nozzle tip 300 from above, so that the nozzle tip 300 is attached to the nozzle 400.

Here, the rack body 200 supports the support member 100 such that the support member 100 is movable in the X axis direction. In other words, since the clearance 11 is provided between the support member 100 and the restriction portion 202, the support member 100 is movable in the range of the clearance 11 in the X axis direction. Accordingly, even if a positioning error occurs between the nozzle tips 300 supported by the first holes 101 and the nozzles 400, the nozzle tips 300 moves together with the support member 100 along with insertion of the nozzles 400 into the nozzle tips 300, and thus the nozzle tips 300 are positioned at the center position of the nozzles 400. In the above manner, the nozzle tips 300 can be properly attached to the nozzles 400.

In this configuration, the nozzle tips 300 are not positioned at the centers of the nozzles 400 by moving the entire tip rack 10, but the positioning adjustment is performed by moving only the support member 100 which is lighter than the rack body 200. As a result, the nozzle tips 300 can be positioned at the centers of the nozzles 400 by inserting the nozzles 400 into the nozzle tips 300.

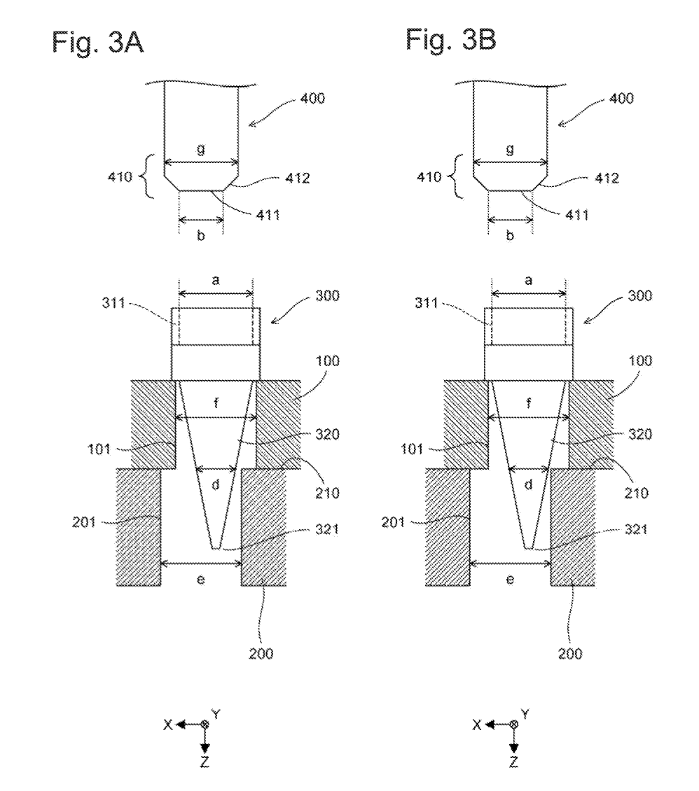

With reference to the schematic diagrams illustrated in FIGS. 2A to 3B, descriptions are provided for attaching a nozzle tip 300 to a nozzle 400. FIGS. 2A to 3B illustrates a nozzle tip 300 supported by the tip rack 10, and indicates a, b, d, e, f, and g as values indicating the lengths of several portions.

As illustrated in FIG. 2A, the distal end portion 410 is provided at the lower end of the nozzle 400. Formed at the distal end portion 410 are a lower surface 411 parallel to the XY plane and inclined surfaces 412 that come closer to the center of the nozzle 400 toward the lower surface 411. The diameter of the opening 311 at the upper end of the nozzle tip 300 is a. The minimum width of the distal end portion 410 is b, and the maximum width of the distal end portion 410 is g. Specifically, the length b is the minimum width of the lower surface 411, and the length g is the width of a portion of the distal end portion 410 to be fitted to the opening 311. The diameter of the cross section of the nozzle tip 300 at the upper surface 210 of the rack body 200 is d. The diameter of the second hole 201 of the rack body 200 is e, the diameter of the first hole 101 of the support member 100 is f.

FIG. 2A illustrates a state where the center axes of the nozzle 400 and the nozzle tip 300 are coincident. In this case, when the nozzle 400 moves in the Z axis positive direction from the state illustrated in FIG. 2A, the distal end portion 410 of the nozzle 400 is fitted to the opening 311 and the nozzle tip 300 is properly attached to the nozzle 400 as illustrated in FIG. 2B.

Here, as illustrated in FIG. 3A, the center axes of the nozzle 400 and the nozzle tip 300 are offset relative to each other in some cases. In FIG. 3A, the nozzle tip 300 and the support member 100 are shifted in the X axis negative direction, and the end position on the X axis positive side of the lower surface 411 of the nozzle 400 and the end position on the X axis positive side of the opening 311 of the nozzle tip 300 are coincident. In this case, when the nozzle 400 is moved in the Z axis positive direction from the state illustrated in FIG. 3A, the lower surface 411 enters the opening 311, and the end on the X axis positive side of the opening 311 receives force in the X axis positive direction from the inclined surface 412 located on the X axis positive side of the nozzle 400. As a result, the nozzle tip 300 and the support member 100 supporting the nozzle tip 300 move in the X axis positive direction, the center axes of the nozzle 400 and the nozzle tip 300 are made coincident in the same manner as the state illustrated in FIG. 2B. Thus, also in this case, the nozzle tip 300 is properly attached to the nozzle 400.

Thus, according to Embodiment 1, since the clearances 11 are provided between the support member 100 and the restriction portions 202 as described above, the support member 100 is movable in the X axis direction. As a result, even if the center axes of the nozzle tip 300 and the nozzle 400 are deviated from each other, the nozzle tip 300 is positioned at the center of the nozzle 400 along with insertion of the nozzle 400 into the nozzle tip 300. Thus, the nozzle tip 300 can be properly attached to the nozzle 400.

In addition, there is a case where the center axes of the nozzle 400 and the nozzle tip 300 are offset relative to each other as illustrated in FIG. 3B. In FIG. 3B, the nozzle tip 300 and the support member 100 are further shifted in the X axis negative direction from the state illustrated in FIG. 3A. In this case, when the nozzle 400 moves in the Z axis positive direction from the state illustrated in FIG. 3B, the lower surface 411 fails to enter the opening 311, and unlike the case in FIG. 3A, the nozzle tip 300 receives no force in the X axis positive direction. Hence, in the case of FIG. 3B, the nozzle tip 300 and the support member 100 supporting the nozzle tip 300 do not move in the X axis positive direction, so that the nozzle tip 300 is not properly attached to the nozzle 400.

As above, since when the movement range of the support member 100 is too large, the nozzle tip 300 cannot be properly attached as in FIG. 3B, the movement range of the support member 100 needs to be set within a certain range. Hereinafter, with reference to FIGS. 2A to 3B, descriptions are provided for conditions for properly attaching the nozzle tip 300 to the nozzle 400, using the lengths of several portions, a, b, d, e, f, and g, and the distance c which the support member 100 is movable by.

The state illustrated in FIG. 3B can occur, for example, when the movement range of the support member 100 relative to the rack body 200, in other words, the distance c which the support member 100 is movable by in the X axis direction based on the clearances 11 is too large. Thus, the distance c which the support member 100 is movable by in the X axis direction needs to be set such that the area of opening 311 does not deviates from the area of the lower surface 411 of the nozzle 400. In addition, even when the distal end portion 410 is within the area of the opening 311, it is preferable that the axes of the nozzle 400 and the nozzle tip 300 can be coincident. The condition of the distance c for the above is expressed by the following expression (1).

a−g≤c≤a−b (1)

The above expression (1) indicates that the movement range of the support member 100 allowed by the clearances 11 is set larger than or equal to the difference between the diameter a of the opening 311 of nozzle tip 300 and the maximum width g of the distal end portion 410 of the nozzle 400 to be inserted into the opening 311. The above expression (1) also indicates that the movement range of the support member 100 allowed by the clearances 11 is set smaller than or equal to the difference between the diameter a of the opening 311 of the nozzle tip 300 and the minimum width b of the distal end portion 410 of the nozzle 400 to be inserted into the opening 311.

When the above expression (1) is satisfied, even if the distal end portion 410 is within the area of the opening 311, at least the center axes of the nozzle 400 and the nozzle tip 300 can be made coincident. In addition, even if the support member 100 is positioned at a limit position of the movement range, the lower surface 411 of the nozzle 400 does not touch the outer edge of the opening 311 of the nozzle tip 300, and the distal end portion 410 of the nozzle 400 is properly inserted into the opening 311. Accordingly, the nozzle tip 300 can be properly attached to the nozzle 400.

In addition, when the support member 100 is moved in the X axis direction as illustrated in FIG. 3A, it is necessary to prevent the lower portion 320 of the nozzle tip 300 from touching the second hole 201 of the rack body 200. A condition for this is expressed by the following expression (2).

d+c≤e (2)

The expression (2) indicates that the diameter of the second hole 201 is set such that when the support member 100 is moved in the movement range of the support member 100 allowed by the clearances 11, the side surface of the nozzle tip 300 supported by the first hole 101 does not touch the inner surface of the second hole 201. In the case where the above expression (2) is satisfied, even if the nozzle tip 300 moves in the X axis direction along with movement of the support member 100, the side surface of the nozzle tip 300 is not inclined by touching the inner surface of the second hole 201. Hence, the nozzle tip 300 can be properly attached to the nozzle 400.

In addition, the second hole 201 of the rack body 200 prevents the nozzle tip 300 from being inclined when the nozzle tip 300 is supported by the first hole 101 of the support member 100. A condition for this is expressed by the following expression (3).

e≤f (3)

The above expression (3) indicates that the diameter of the second hole 201 is set smaller than or equal to the diameter of the first hole 101. When the above expression (3) is satisfied, even if the nozzle tip 300 inclines from the center axis of the first hole 101, the distal end 321 of the nozzle tip 300 touching the inner side surface of the second hole 201 prevents the nozzle tip 300 from inclining when the nozzle tip 300 is supported by the support member 100. Accordingly, the nozzle tip 300 can be properly attached to the nozzle 400.

Note that although the tip rack 10 illustrated in FIGS. 1A and 1B is configured to be able to support multiple nozzle tips 300, the tip rack 10 may be configured to support only one nozzle tip 300. In addition, although FIGS. 1A and 1B illustrate the tip rack 10 which supports multiple nozzle tips 300 aligned in the X axis direction, the tip rack 10 may support multiple nozzle tips 300 aligned in the X axis direction and the Y axis direction as illustrated as a specific configuration described below.

### <Specific Configuration>

Next, the configuration of the tip rack 10 illustrated in FIGS. 1A to 3B is described more specifically.

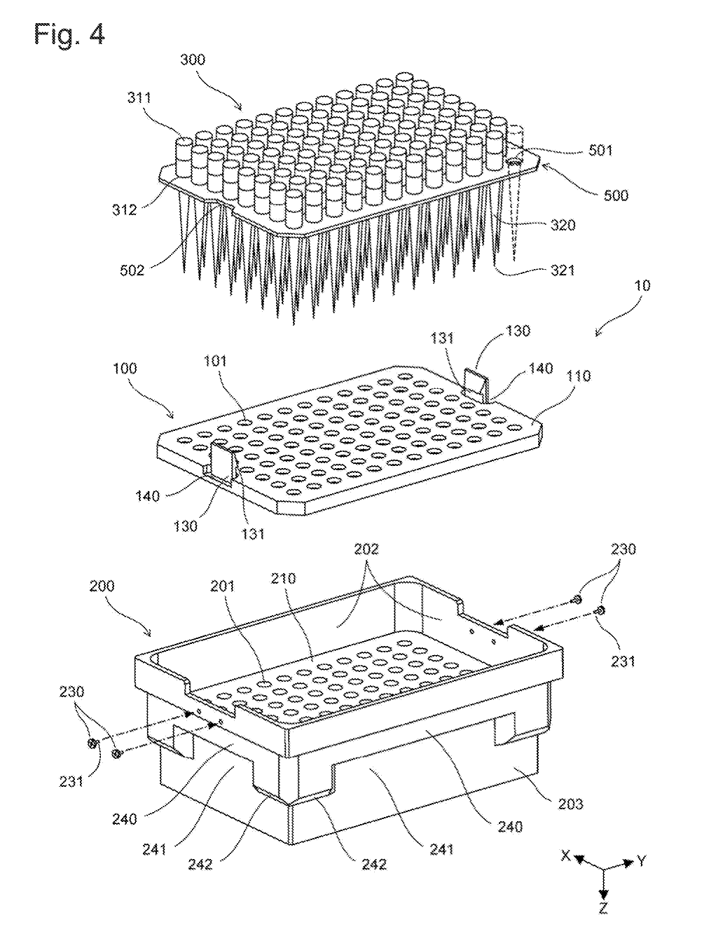

As illustrated in FIG. 4, first holes 101 are formed in a support member 100 in a matrix shape. Specifically, twelve sets of eight first holes 101 aligned in the X axis direction are aligned in the Y axis direction, and thus a total of 96 first holes 101 are formed. As described above, by providing the first holes 101 such that the first holes 101 are aligned with each other longitudinally and laterally in the support member 100, it is possible to attach multiple nozzle tips 300 supported by the first holes 101 in each column to multiple nozzles 400 at one time.

The support member 100 is provided with temporary fixing portions 130 or a provisionally fixing portion and recesses 140 at the ends on the Y axis negative side and the Y axis positive side. The temporary fixing portion 130, protruding upward from an upper surface 110, is provided with a protrusion 131 oriented inward of the support member 100. The recess 140 is a dent recessed inward of the support member 100 from the side surface of the support member 100 and has a surface lower by one step than the upper surface 110.

Formed in a rack body 200 in a matrix shape are second holes 201 in the same manner as the support member 100. A restriction portion 202 surrounds an upper surface 210 from the four directions, the X axis positive side, the X axis negative side, the Y axis positive side, and the Y axis negative side.

When the support member 100 and the rack body 200 are assembled together, the support member 100 is, first, positioned inside the restriction portion 202, and placed on the upper surface 210 of the rack body 200. Here, the upper surface 210 of the rack body 200 is a support surface that supports the support member 100 such that the support member 100 is movable in the X axis direction and the Y axis direction. The upper surface 210 functioning as the support surface makes it possible to stably support the support member 100. In addition, the surface of the upper surface 210 is processed to have a smooth surface to make friction force with the lower end of the support member 100 small.

Then, screws 230 are attached to holes formed in the restriction portion 202 on the Y axis positive side and the Y axis negative side of the rack body 200. After the screws 230 are attached, contact portions 231 of the screws 230, in other words, shaft portions of the screws 230 protrude from the holes formed in the restriction portion 202 on the Y axis positive side and the Y axis negative side, to the inside of the rack body 200. At this time, the contact portions 231 of the screws 230 are positioned immediately above the recesses 140 of the support member 100. Thus, the assembly of the tip rack 10 is completed.

A second support member 500 is a thin plate member, and the outline shape thereof viewed in the Z axis direction is the same as that of the support member 100. The second support member 500 include 96 holes 501 and two indentations 502. The 96 holes 501 are arranged at the positions corresponding to the 96 first holes 101 of the support member 100. The diameter of the holes 501 is the same as that of the first holes 101. The indentations 502 are provided at the ends on the Y axis negative side and the Y axis positive side of the second support member 500. As illustrated in FIG. 4, 96 new nozzle tips 300 are supported on the second support member 500 when they are sold in the market.

When setting the nozzle tips 300 to the tip rack 10, an operator takes a second support member 500 with 96 nozzle tips 300 supported thereon out of a package as illustrated in FIG. 4. Then, the operator sets the second support member 500 with the 96 nozzle tips 300 supported thereon on the upper surface 110 of the support member 100. At this time, the indentations 502 of the second support member 500 are engaged with the protrusions 131 of the temporary fixing portions 130 provided for the support member 100. As described above, when the nozzle tips 300 are supported on the support member 100 in the state where the nozzle tips 300 are supported on the second support member 500, the temporary fixing portions 130 temporarily or provisionally fix the second support member 500 to the upper surface 110 of the support member 100. With this structure, it possible to let the support member 100 support the nozzle tips 300 together with the second support member 500.

Here, as described above, the contact portions 231 of the screws 230 protrude from the rack body 200 toward the support member 100 at positions higher than the upper surface 110 of the support member 100. In other words, the contact portions 231 are protrusions protruded from the rack body 200 toward the support member 100. The contact portions 231 of the screw 230 are positioned immediately above the recesses 140 of the support member 100. With this structure, even if the support member 100 seeks to get apart from the rack body 200 in the Z axis positive direction, the contact portions 231 come into contact with the recesses 140 of the support member 100, so that the support member 100 getting apart in the Z axis positive direction is restricted.

As described above, in the case where the movement of the support member 100 in the Z axis positive direction is restricted, even if it a nozzle tip 300 is not easily pulled out of the first hole 101, it is possible, after the nozzle tips 300 are attached to the nozzles 400, to prevent the support member 100 from being raised together with the nozzle tip 300 along with the upward movement of the nozzles 400.

The protrusions protruding from the rack body 200 are formed by the contact portions 231 protruding inward of the restriction portion 202. With this structure, the contact portions 231 can be formed simply and at low cost.

Note that the contact portions 231 may be formed as protrusions provided on the restriction portion 202 and extending in the X axis direction. In this case, the support member 100 may be set on the upper surface 210 by sliding the support member 100 between the protrusions and the upper surface 210 in the X axis direction. This structure makes it possible to prevent the support member 100 from being raised in the Z axis positive direction, by the protrusions provided for the rack body 200 and extending in the X axis direction.

A base 203 of the rack body 200 in which the second holes 201 are provided is filled with a material of which the rack body 200 is made excluding the second holes 201. This makes the weight of the rack body 200 large. As a result, even if a nozzle tip 300 is not easily pulled out of the first hole 101, it is possible to prevent the rack body 200 from being raised together with the nozzle tip 300 along with the upward movement of the nozzles 400 after the nozzle tips 300 are attached.

Here, the support member 100 is made of polypropylene. The rack body 200 is made of polyacetal. In general, the specific gravity of the polypropylene is 0.90 to 0.91, and the specific gravity of polyacetal is 1.41. The specific gravity of the rack body 200 is larger than that of the support member 100. If the specific gravity of the material of which the rack body 200 is made is larger than that of the material of which the support member 100 is made as described above, it is possible to more positively prevent the rack body 200 from being raised together with the nozzle tip 300.

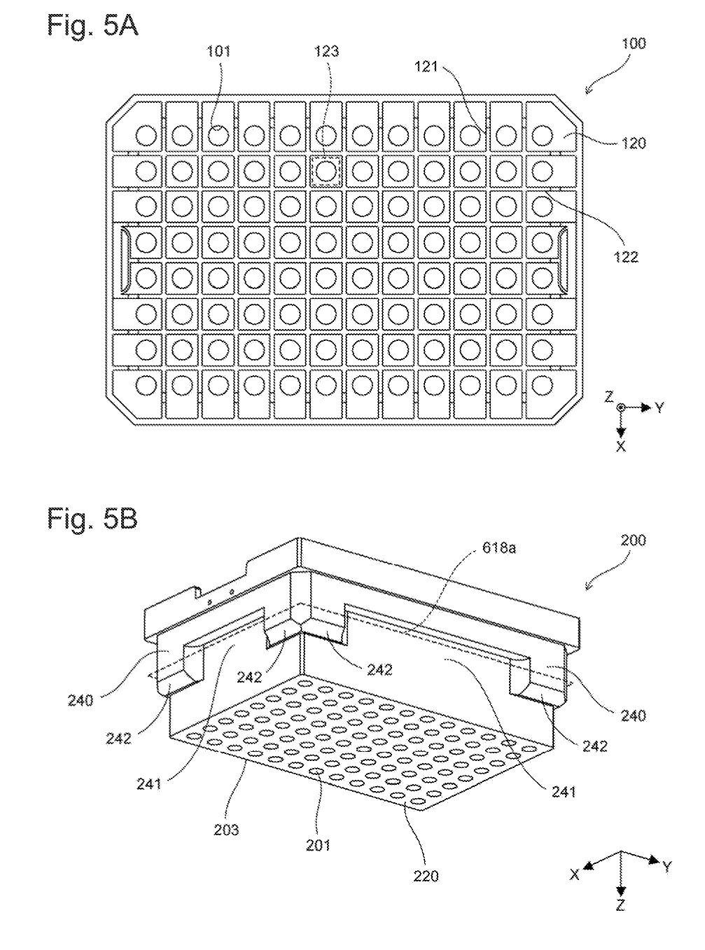

FIG. 5A is a plan view of a lower surface 120 of the support member 100 when viewed in the Z axis negative direction. On the lower surface 120 of the support member 100, walls 121 and 122 protruding in the Z axis positive direction and having a constant height are formed in a lattice shape. Specifically, formed on the lower surface 120 of the support member 100 are eleven walls 121 extending in the X axis direction and parallel to the XZ plane and seven walls 122 extending in the Y axis direction and parallel to the YZ plane. The lower ends of walls 121 and 122 are positioned to the same plane parallel to the XY plane. The support member 100 is set to the rack body 200 by placing the lower ends of the walls 121 and 122 onto the upper surface 210 of the rack body 200. Note that the walls 121 and 122 may be replaced with bosses or protrusions extending in the Z axis positive direction from the lower surface 120.

The distance between the first holes 101 and the second holes 201 can be increased by the walls 121 and 122. Accordingly, when the tapered nozzle tip 300 is supported by the first hole 101, the width of the nozzle tip 300 at the position of the second hole 201 is much smaller than the width of the nozzle tip 300 at the position of the first hole 101. With this configuration, even if the nozzle tip 300 moves in the X axis direction and the Y axis direction along with the movement of the support member 100, it is possible to prevent the nozzle tip 300 from being inclined by the side surface thereof touching the inner side surface of the second hole 201. In addition, providing the walls 121 and 122 in a lattice shape contributes to the weight reduction of the support member 100 and keeping the strength of the support member 100 high. As a result, it is possible to move the support member 100 smoothly within the range allowed by the clearances 11, as well as make the support member 100 strong enough to withstand the force exerted when the nozzles 400 are inserted into the nozzle tips 300. In addition, since the contact area between the support member 100 and the upper surface 210 of the rack body 200 can be small, it is possible to move the support member 100 smoothly.

The walls 121 and 122 are formed such that areas 123 surrounded by the walls 121 and 122 are aligned with each other longitudinally and laterally in the XY plane. The first hole 101 is formed in each area 123. With this structure, multiple nozzle tips 300 can be supported by the tip rack 10. In addition, since the first holes 101 are arranged to be aligned, the nozzle tips 300 supported by the first holes 101 in each column can be attached to the nozzles 400 at one time.

As illustrated in FIGS. 4 and 5B, at outer peripheral surfaces 240 of the rack body 200 are formed depressions 241 depressed inward of the rack body 200. Specifically, the depressions 241 are each formed at portions of the outer peripheral surfaces 240 on the X axis positive side, the X axis negative side, the Y axis positive side, and the Y axis negative side. In addition, at the outer peripheral surface 240 are formed inclined surfaces 242 which extend gradually outward of the rack body 200 while extending upward.

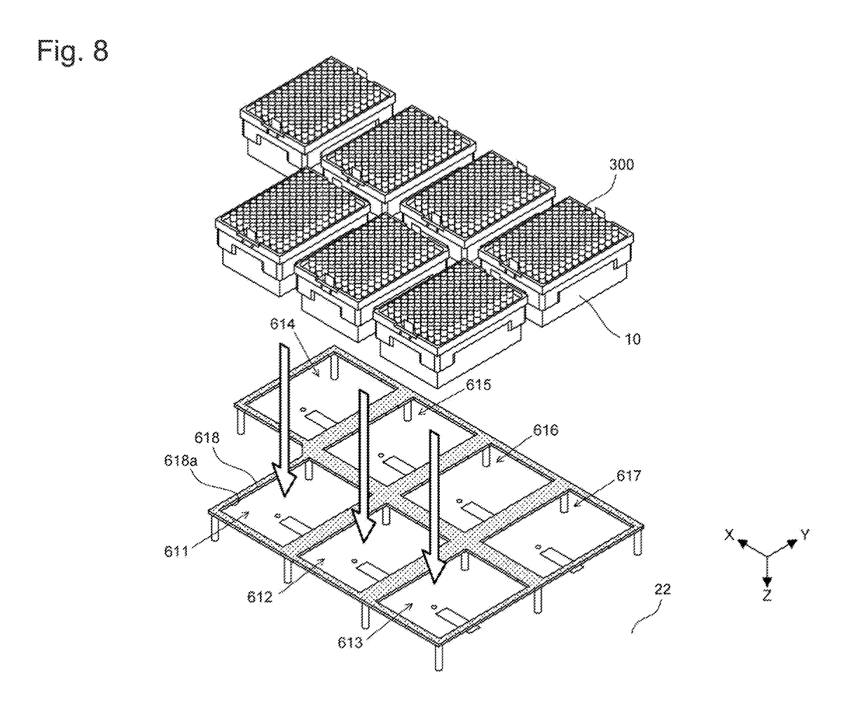

In FIG. 5B, an opening 618a of a frame 618 on the apparatus side where the tip rack 10 is set is indicated by a broken line. The opening 618a of the frame 618 is described later with reference to FIG. 8. When the tip rack 10 with the nozzle tips 300 set therein is set into the apparatus, being fitted to the opening 618a, the opening 618a is positioned at the position of the outer peripheral surfaces 240. In this case, the areas where the depressions 241 are provided do not contact the opening 618a. The surfaces of the outer peripheral surfaces 240 are processed to have smooth surfaces to make friction force from the opening 618a small. Hence, it is possible to reduce the friction force generated between the tip rack 10 and the opening 618a, and thus, the tip rack 10 can be smoothly fitted into the opening 618a. In addition, an operator can easily set the tip rack 10 to the apparatus by hooking fingers to the depressions 241 to grasp the tip rack 10.

In addition, the tip rack 10 is guided by the inclined surfaces 242 and positioned at the center of the opening 618a. Thus, the tip rack 10 can be smoothly fitted into the opening 618a.

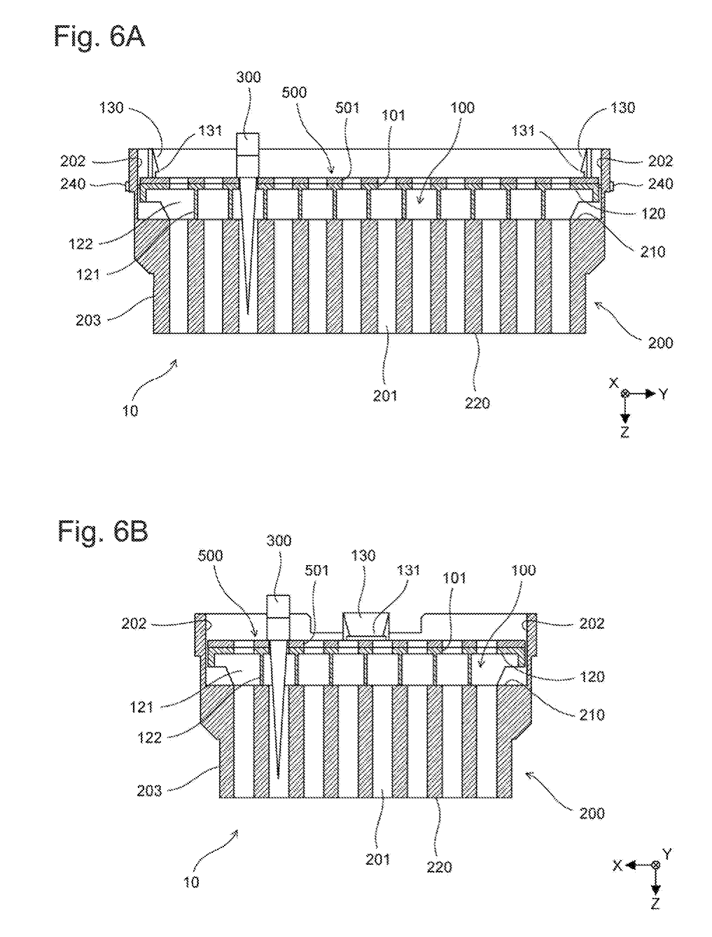

FIGS. 6A and 6B are diagrams illustrating the tip rack 10 supporting the nozzle tip 300. FIG. 6A is a diagram of a cross section of the tip rack 10 taken along a plane which is parallel to the YZ plane and passes through the twelve first holes 101 aligned at the end on the X axis negative side, when viewed in the X axis positive direction. FIG. 6B is a diagram of a cross section of the tip rack 10 taken along a plane which is parallel to the XZ plane and passes through the eight first holes 101 aligned at the end on the Y axis negative side, when viewed in the Y axis positive direction. In FIGS. 6A and 6B, appearance of one nozzle tip 300 placed in the tip rack 10 is illustrated for convenience.

As described with reference to FIG. 5A, formed on the lower surface 120 of the support member 100 are the walls 121 and 122 extending downward, and the lower ends of the walls 121 and 122 are supported by the upper surface 210 of the rack body 200. The nozzle tip 300 is supported by the support member 100 via the second support member 500, and the lower portion 320 of the nozzle tip 300 passes through the hole 501 of the second support member 500 and the first hole 101 of the support member 100, and into the second hole 201 of the rack body 200.

As described in FIG. 5A, the lengths of the support member 100 and the second support member 500 are the same in the Y axis direction, and the length of the support member 100 is smaller than the distance between the restriction portions 202 on the Y axis positive side and the Y axis negative side. This setting provides clearances 11 between the support member 100 and the restriction portions 202 in the same way as indicated in FIGS. 1A and 1B. Similarly, as illustrated in FIG. 5B, the lengths of the support member 100 and the second support member 500 are the same in the X axis direction, and the length of the support member 100 is smaller than the distance between the restriction portions 202 on the X axis positive side and the X axis negative side. This setting provides clearances 11 between the support member 100 and the restriction portions 202 in the same way as indicated in FIGS. 1A and 1B.

Accordingly, the restriction portions 202 illustrated in FIGS. 5A and 5B face the outer periphery of the support member 100 with the clearance 11 in between, and allows the movement of the support member 100 within the range of the clearance 11 in the X axis direction and the Y axis direction. In other words, the support member 100 and the nozzle tip 300 supported by support member 100 are movable in the XY plane within a specified range.

Note that the length of the support member 100 in the Y axis direction is 119.4 mm, and the distance between the restriction portions 202 on the Y axis positive side and the Y axis negative side is 120.4 mm. The length of the support member 100 in the X axis direction is 82.7 mm, and the distance between the restriction portions 202 on the X axis positive side and the X axis negative side is 83.8 mm. Accordingly, the support member 100 is movable by about 1 mm in the X axis direction and the Y axis direction.

Next, descriptions are provided for a sample processing apparatus which performs processing using the tip rack 10. The sample processing apparatus of Embodiment 1 is an apparatus for performing pretreatment on samples for a gene test when detecting a gene based on BEAMing (Bead, Emulsion, Amplification, and Magnetics) method. Specifically, the sample processing apparatus of Embodiment 1 is a sample processing apparatus for a gene test.

Note that the BEAMing method is a gene analysis method combining digital PCR technology and flow cytometry technology. The digital PCR is a measurement method for measuring the concentration of a target gene in a sample in an absolute manner, in which sample DNAs subjected to limiting dilution (dilution such that one or zero target DNA is in each minute section) are dispersed in minutes sections, PCR amplification is performed, and then the number of the minute sections the amplified signals of which are positive is directly counted. The amplified signals of minute sections including the target gene are positive, and the amplified signals of minute sections not including the target gene or the sample DNA itself are negative.

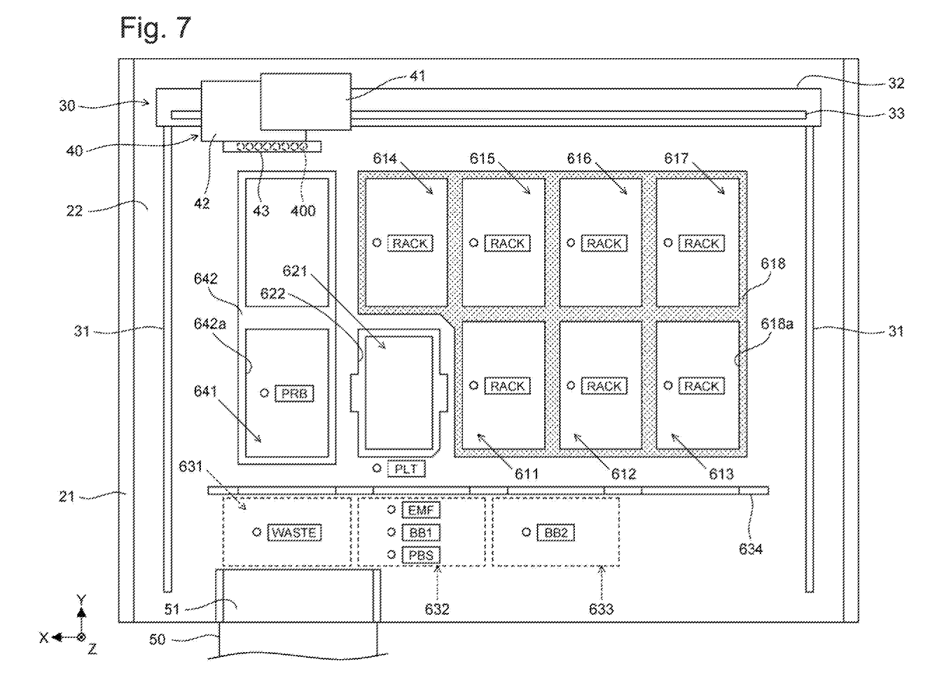

The BEAMing method includes, for example, a DNA extraction process, a dilution process, an emulsion preparation process, a PCR process, an emulsion breaking process, a hybridization process, a cleaning process, and a measurement process with a flow cytometer. Of those processes, a sample processing apparatus 20 illustrated in FIG. 7 performs the emulsion preparation process, the emulsion breaking process, and the cleaning process.

As illustrated in FIG. 7, the sample processing apparatus 20 includes a bottom surface 22, a transfer unit 30, a dispensing unit 40, a nozzle tip disposal section 50, tip rack placement sections 611 to 617, a microplate placement section 621, and reagent container placement sections 631 to 633, and 641, inside a housing 21.

The transfer unit 30 moves the dispensing unit 40 to the tip rack placement sections 611 to 617, the microplate placement section 621, and the reagent container placement sections 631 to 633, and 641. The transfer unit 30 includes two rails 31, a front-rear moving member 32, and a rail 33. The two rails 31 extend in the front-rear direction. The front-rear moving member 32 and the rail 33 extend in the right-left direction. The front-rear moving member 32 is movable in the front-rear direction along the two rails 31. The rail 33 is attached on the front-rear moving member 32. The transfer unit 30 further includes a non-illustrated front-rear drive unit and right-left drive unit. The transfer unit 30 moves the front-rear moving member 32 in the front-rear direction along the two rails 31 using the front-rear drive unit. The transfer unit 30 moves the dispensing unit 40 in the right-left direction along the rail 33 using the right-left drive unit.

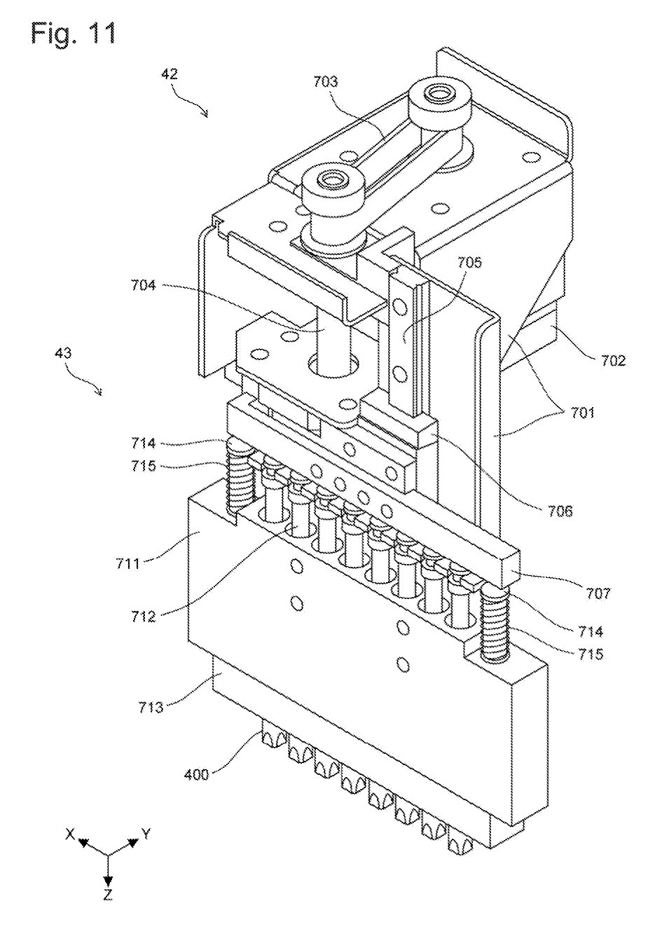

The dispensing unit 40, with the nozzle tips 300 attached thereon, sucks or discharges liquid. The dispensing unit 40 includes a first drive mechanism 41, a second drive mechanism 42, and a suction and discharge unit 43. The dispensing unit 40 is movable in the right-left direction along the rail 33. The first drive mechanism 41 moves the second drive mechanism 42 and the suction and discharge unit 43 vertically along a non-illustrated rail extending vertically. The second drive mechanism 42 move vertically cylinders 712 which is to be described later with reference to FIG. 11. By the cylinders 712 moving up and down, suction and discharge are performed through the nozzle tips 300 attached to eight nozzles 400 of the suction and discharge unit 43. The eight nozzles 400 are aligned laterally at certain intervals. The configurations of the second drive mechanism 42 and the suction and discharge unit 43 are described later with reference to FIGS. 11 to 14B.

Placed at the nozzle tip disposal section 50 is a disposal bag 51. Discarded into the disposal bag 51 are used nozzle tips 300.

As illustrated in FIG. 8, an operator places the tip racks 10 to the tip rack placement sections 611 to 617 as indicated by the outlined arrows. Eight nozzle tips 300 placed in the tip rack 10 in the X axis direction are aligned at the same intervals as those of eight nozzles 400. The tip rack placement sections 611 to 617 include seven openings 618a of a frame 618 attached to the bottom surface 22, and the bottom surface 22. The seven openings 618a have an outline into which the outer peripheral surfaces 240 of the tip racks 10 fit.

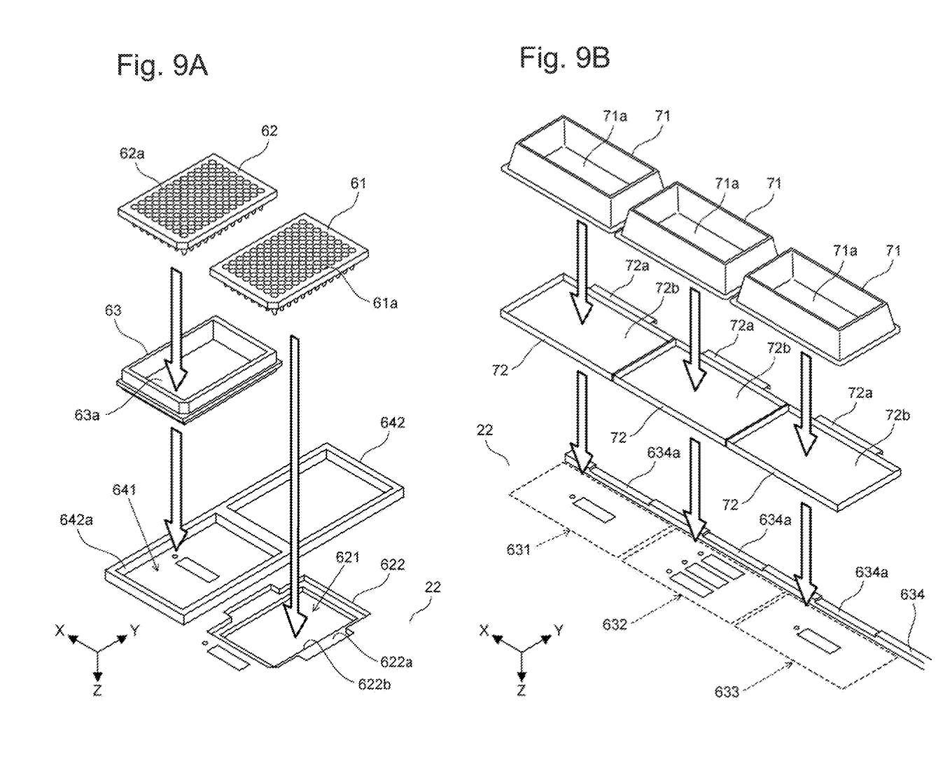

As illustrated in FIG. 9A, placed in the microplate placement section 621 is a microplate 61. The microplate 61 has wells 61a in recessed shapes. The wells 61a are provided on the upper surface of the microplate 61 in rows and columns with intervals in between. Specifically, a total of 96 wells 61a are provided on the upper surface of the microplate 61 such that twelve pieces are aligned in the front-rear direction and eight pieces are aligned in the right-left direction. The eight wells 61a in the right-left direction are arranged at the same intervals as those of the eight nozzles 400. The wells 61a contain target DNA molecules and the like.

The microplate placement section 621 includes a recess 622 formed in the bottom surface 22. The recess 622 has an outline into which the microplate 61 fits. The recess 622 has a bottom surface 622a and an opening 622b. The bottom surface 622a is located at a lower position than the bottom surface 22 by one step. The bottom surface 622a supports a collar portion of the outer peripheral of the microplate 61 when it is placed to the microplate placement section 621. The opening 622b is provided at the center of the bottom surface 622a. Through the opening 622b, magnetic force from a non-illustrated magnet member is applied to the wells 61a.

Next, as illustrated in FIG. 9A, placed to the reagent container placement section 641 is a reagent container 62. The reagent container 62 has the same configuration as that of the microplate 61. Specifically, the reagent container 62 has recessed reagent containing portions 62a. A total of 96 reagent containing portions 62a are provided on the upper surface of the reagent container 62 such that twelve pieces are aligned in the front-rear direction and eight pieces are aligned in the right-left direction. The eight reagent containing portions 62a in the right-left direction are aligned at the same intervals as those of the eight nozzles 400. The reagent containing portions 62a contain reagents including label probes capable of hybridization for amplified target DNA molecules.

The reagent container placement section 641 includes a frame 642 attached to the bottom surface 22. The frame 642 has a rectangular opening 642a. Set to the opening 642a is an adapter 63. The lower portion of the adapter 63 has an outline into which the opening 642a of the frame 642 fits. The adapter 63 is attachable to and detachable from the opening 642a. In ordinary usage, the adapter 63 is set to the opening 642a in advance. The adapter 63 has an opening 63a passing therethrough in the up-down direction. The upper portion of the adapter 63 has an outline that fits the inside of the outer peripheral side surfaces of the reagent container 62.

As illustrated in FIG. 9B, placed to the reagent container placement sections 631 to 633 are reagent containers 71. The reagent container 71 has a substantially rectangular outline in plan view and a substantially trapezoidal outline in side view. At the reagent container placement section 631, an empty reagent container 71 is placed for storing waste liquid. Placed to the reagent container placement section 632 is a reagent container 71 that contains an emulsion reagent, a first breaking reagent, or phosphate buffered saline. Hereinafter, the phosphate buffered saline is referred to as “PBS”. Placed to the reagent container placement section 633 is a reagent container 71 that contains a second breaking reagent. In the reagent container 71, a recess 71a is formed for containing liquid. The lateral length of the recess 71a is larger than that of the eight nozzles 400.

The emulsion reagent is a reagent for forming an oil phase in an aqueous phase containing magnetic beads to which primer molecules are bound for amplification of target DNA molecules. The emulsion reagent includes silicone emulsifiers and oils. The first and second breaking reagents are breaking reagents for breaking water-in-oil (W/O type) emulsion subjected to PCR. The first and second breaking reagents include alcohols and surface-active agents. The amount of alcohol contained in the first breaking reagent is larger than that in the second breaking reagent in order to break the droplets. The amount of alcohol contained in the second breaking reagent is smaller than that in the first breaking reagent in order to adjust the state of target DNA molecules. PBS is a reagent used in the cleaning process to be described later.

The reagent container placement sections 631 to 633 include the bottom surface 22 and a bar 634. The bar 634 is attached to the bottom surface 22. Formed in the bar 634 are three recesses 634a. Adapters 72 each include an engaging portion 72a and a recess 72b. The engaging portion 72a is engaged with the recess 634a. The recess 72b has a substantially rectangular outline into which the bottom portion of the reagent container 71 fits. Engagement of the engaging portion 72a with the recess 634a of the bar 634 determines the position for setting the adapter 72 on the bottom surface 22. The reagent container 71 is set in the recess 72b of the positioned adapter 72.

Next, descriptions are provided for a layout for accommodating the microplate 61 when starting the emulsion preparation process, and a layout for accommodating the reagent container 62 when starting the emulsion breaking process.

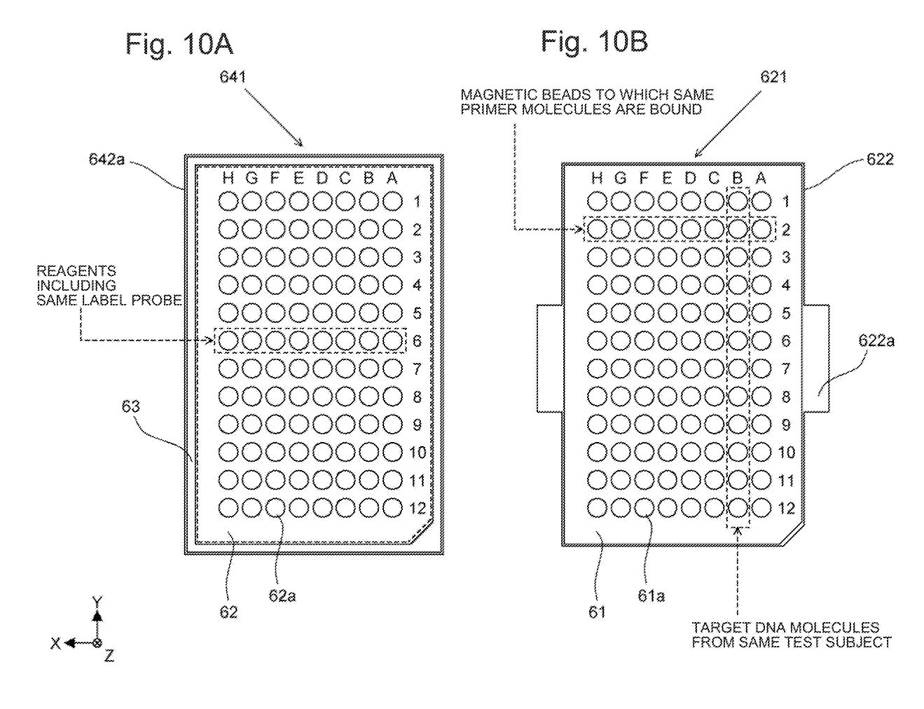

As illustrated in FIGS. 10A and 10B, the numerals 1 to 12 written on the upper surfaces of the microplate 61 and the reagent container 62 indicate column numbers. The letters A to H written on the upper surfaces of the microplate 61 and the reagent container 62 indicate row numbers. One row indicates twelve wells 61a and reagent containing portions 62a aligned in the front-rear direction, and one column indicates eight wells 61a and reagent containing portions 62a aligned in the right-left direction. Hence, on the microplate 61 and the reagent container 62, the wells 61a and reagent containing portions 62a are aligned in twelve columns in the front-rear direction and eight rows in the right-left direction.

The wells 61a of the microplate 61 contain target DNA molecules and magnetic beads to which primer molecules are bound for amplifying target DNA molecules. For example, the wells 61a in one row contain target DNA molecules from the same test subject. For example, the wells 61a in one column contain magnetic beads to which the same primer molecules are bound. In this case, one microplate 61 allows a test for twelve test subjects using eight different primer molecules.

Magnetic beads contained in a well 61a include magnetic beads to which primer molecules are bound for amplifying mutated target DNA molecules and magnetic beads to which primer molecules are bound for amplifying normal target DNA molecules. Hereinafter, mutated target DNA molecules are referred to as “mutant DNA molecules” and normal target DNA molecules “wild-type DNA molecule”.

The reagent containing portions 62a of the reagent container 62 contain reagents including label probes. The reagent containing portions 62a in one row contain reagents including the same label probe. Label probes contained in one reagent containing portion 62a include label probes that are specifically bound to mutant DNA molecules and label probes that are specifically bound to wild-type DNA molecules. One reagent container 62 contains reagents including eight different combinations of label probes. The reagent containing portions 62a correspond to respective wells 61a on the microplate 61. In other words, the label probes contained in the reagent containing portions 62a in each column label the target DNA molecules in the wells 61a in the same column.

Hence, the transfer unit 30 and the dispensing unit 40 dispense reagents including label probes, associating reagent containing portions 62a with wells 61a corresponding the reagent containing portions 62a on a one-to-one basis. In other words, the reagent in a reagent containing portion 62a is dispensed in the well 61a located at the same position in the front-rear direction and the right-left direction as that of the reagent containing portion 62a.

Next, configurations of the second drive mechanism 42 and the suction and discharge unit 43 are described.

As illustrated in FIG. 11, the second drive mechanism 42 includes a base member 701, a stepping motor 702, a belt 703, a shaft 704, a rail 705, a slider 706, and a lift bar 707. The suction and discharge unit 43 includes a holder 711, eight cylinders 712, a remover 713, two shafts 714, two springs 715, and eight nozzles 400.

The base member 701 is moved vertically by the first drive mechanism 41 of the dispensing unit 40 illustrated in FIG. 7. The stepping motor 702 is attached to the base member 701. The belt 703 transmits the rotational driving force generated by the stepping motor 702 to the shaft 704. The shaft 704 is rotatably supported by the base member 701. The rail 705, extending vertically, is attached to the base member 701.

The slider 706 is supported by the rail 705 to be movable in the up-down direction. The shaft 704 has a screw thread formed on the outer peripheral surface. The shaft 704 is borne by ball bearings connected with the slider 706. When the shaft 704 rotates, the driving force is transmitted to the slider 706 via the ball bearings. This causes the slider 706 to move along the rail 705. The lift bar 707 is attached to the slider 706. With this configuration, when the stepping motor 702 is driven, the lift bar 707 moves vertically.

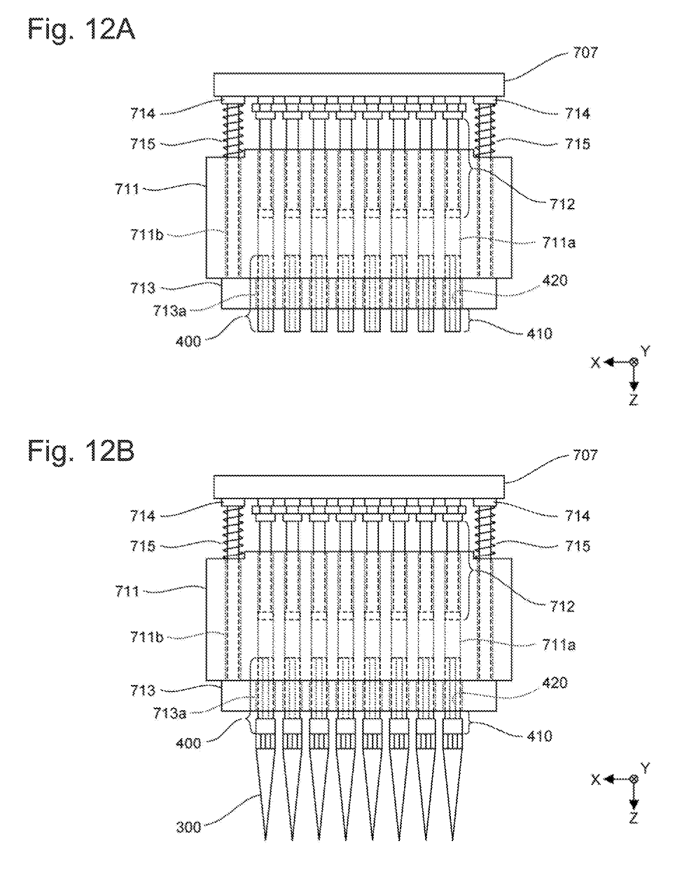

As illustrated in FIGS. 11 and 12A, the holder 711 is attached to the base member 701. The holder 711 has eight holes 711a, and two holes 711b on the both sides of the eight holes 711a. The holes 711a and 711b pass through the holder 711 vertically. The eight cylinders 712 are each inserted in the eight holes 711a from the upper side thereof. The eight nozzles 400 are set at the lower ends of the eight holes 711a. The nozzle 400 has a hole 420 passing therethrough vertically. The distal end portion 410 of the nozzle 400 has a cylindrical shape.

The remover 713 has eight holes 713a. The holes 713a pass through remover 713 vertically. The eight nozzles 400 are each inserted in the eight holes 713a of the remover 713. The two shafts 714 are each inserted in the holes 711b of the holder 711. The ends of the two shafts 714 are fixed to the upper surface of the remover 713. The springs 715 are connected to the upper ends of the shafts 714 and upper surfaces of the holder 711, and give force to the shafts 714 upward in the state illustrated in FIG. 12A. The biasing from the springs 715 presses the upper surface of the remover 713 against the lower surface of the holder 711.

Next, operation of the suction and discharge unit 43 is described.

When the apparatus is in the standby state, the lift bar 707 is positioned relative to the holder 711 as illustrated in FIG. 12A. At this time, since the shafts 714 are pulled upward by the springs 715, the remover 713 is in contact with the lower surface of holder 711. The distal end portions 410 of the nozzles 400 protrude from the lower surface of the remover 713 by a specified length.

In the state illustrated in FIG. 12A, the dispensing unit 40 is positioned to the tip rack placement sections 611 to 617 by the transfer unit 30. Specifically, the eight nozzles 400 are positioned immediately above the eight nozzle tips 300 which are laterally aligned and placed on the tip rack 10. Then, the second drive mechanism 42 and the suction and discharge unit 43 are moved in the Z axis positive direction by the first drive mechanism 41. This moves down all the nozzles 400 at the same time, and the distal end portions 410 of the nozzles 400 are inserted into the openings 311 of nozzle tips 300.

More specifically, the nozzles 400 are moved to above the rack body 200. The nozzles 400 are moved down relative to the support member 100 supported by the rack body 200, and inserted into the openings 311 at the upper ends of the nozzle tips 300 supported by the first holes 101. Then, the nozzles 400 are further inserted into the nozzle tips 300 the positions of which have been adjusted in a direction parallel to the XY plane by the movement of the support member 100. As a result, the nozzle tips 300 are attached to the nozzle 400 as illustrated in FIG. 12B.

At this time, even if the center axes of the nozzle 400 and the nozzle tip 300 are offset relative to each other as illustrated in FIG. 3A, the nozzle tips 300 are properly attached to the nozzles 400 because the support member 100 supporting the nozzle tips 300 is movable on the upper surface 210 of the rack body 200 as illustrated in FIG. 2B. The movement control of the nozzle 400 is always performed in the same manner regardless of the offset between the center axes of the nozzle 400 and the nozzle tip 300. Even in this case, the nozzle tips 300 are properly attached to the nozzles 400 by the movement of the support member 100 as described above. Hence, the movement control of the nozzle 400 can easily be performed. In addition, attaching the eight nozzle tips 300 to the eight nozzles 400 at the same time shortens the attachment time compared to the case where the nozzle tips 300 are attached one by one.

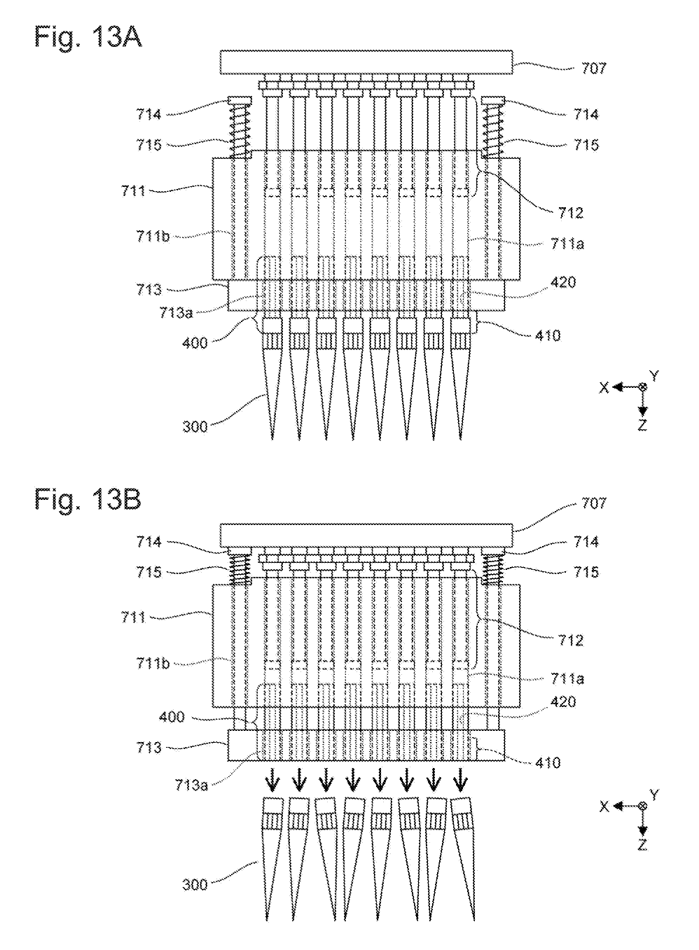

When sucking liquid, the dispensing unit 40 with the nozzle tips 300 attached thereto are transferred by the transfer unit 30 to the microplate placement section 621, the reagent container placement sections 631 to 633, and the reagent container placement section 641. The second drive mechanism 42 and the suction and discharge unit 43 are moved downward by the first drive mechanism 41. With this movement, the distal ends 321 of the nozzle tips 300 are moved to below the surface of the liquid contained in the microplate 61 and the reagent containers 62 and 71. In this state, the lift bar 707 is moved upward by the second drive mechanism 42 as illustrated in FIG. 13A. This movement reduces the pressure inside the hole 711a of the holder 711, and the liquid is sucked from the distal end 321 of the nozzle tip 300. This sucking operation occurs in the eight nozzle tips 300 at the same time.

To discharge the sucked liquid, the lift bar 707 is moved downward by the second drive mechanism 42, and returned to the original position as illustrated in FIG. 12B. This operation discharges the sucked liquid from the distal end 321 of the nozzle tip 300. This discharge operation occurs in the eight nozzle tips 300 at the same time.

When sucking and discharging the liquid is completed, the dispensing unit 40 is positioned immediately above the nozzle tip disposal section 50 by the transfer unit 30. Then, from the state illustrated in FIG. 12B, the lift bar 707 is moved further downward by the second drive mechanism 42. With this movement, the lift bar 707 pushes down the shafts 714 against the force of the springs 715, and the remover 713 moves downward, as illustrated in FIG. 13B. By the remover 713 moving downward, the nozzle tips 300 attached to the distal end portions 410 of the nozzles 400 are pushed down by the lower surface of the remover 713. With this movement, the eight nozzle tips 300 drop from the nozzles 400 at the same time and are received by the disposal bag 51. After that, the lift bar 707 is moved upward by the second drive mechanism 42, and returned to the original position as illustrated in FIG. 12A.

Next, the shape of the distal end portion 410 of nozzle 400 is described.

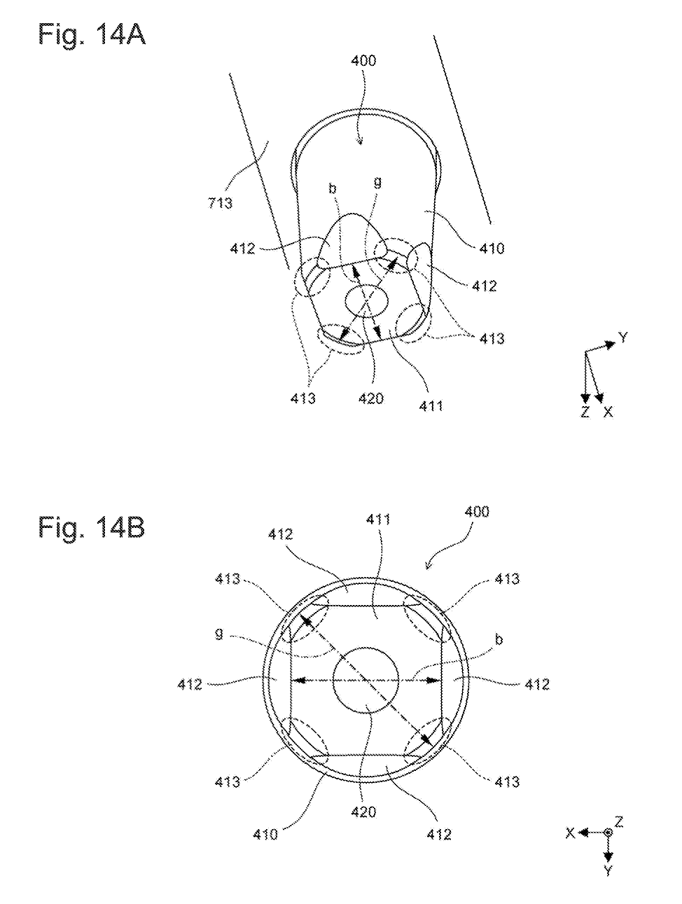

As illustrated in FIGS. 14A and 14B, the side surface of the distal end portion 410 of the nozzle 400 is partially cut away so as to come closer to the center of the nozzle 400 toward the lower surface 411 of the nozzle 400. At the distal end portion 410, side surface portions 413 having substantially the same diameter as that of the opening 311 of the nozzle tip 300 are left at four positions in the circumferential direction. Between the side surface portions 413 are formed inclined surfaces 412 which come closer to the center of the nozzle 400 toward the lower surface 411. The four inclined surfaces 412 are formed at positions in the front, rear, right, and left directions of the distal end portion 410. The minimum width of the distal end portion 410 illustrated in FIG. 2A, in other words, the minimum width of the lower surface 411 is the length b illustrated in FIGS. 14A and 14B. The maximum width of the distal end portion 410 illustrated in FIG. 2A, in other words, the width of the portion of the distal end portion 410 fitted into the opening 311 is the length g illustrated in FIGS. 14A and 14B.

As described above, formed in the nozzle 400 are the side surface portions 413 having substantially the same diameter as the opening 311 of nozzle tip 300 and the inclined surfaces 412 located inward from the side surface portion 413. In this case, when the distal end portion 410 is inserted to the nozzle tip 300, the four side surface portions 413 contact the inside of the opening 311 of nozzle tip 300, so that the nozzle tip 300 is supported by the distal end portion 410 without inclining. In addition, since the four inclined surfaces 412 do not contact the inside of the opening 311 of the nozzle tip 300, even if the nozzle tip 300 has some positional offsets, the distal end portion 410 is inserted into the nozzle tip 300. Accordingly, the shape of the distal end portion 410 of the nozzle 400 also makes it possible to properly attach the nozzle tip 300 to the nozzle 400.

Next, descriptions are provided for the fact that the above expressions (1) to (3) hold in the specific configuration of Embodiment 1.

In the specific configuration, the values of a, b, e, f, and g illustrated in FIGS. 2A to 3B are 6.2 mm, 4.6 mm, 5 mm, 5 mm, and 5.8 mm, respectively. In addition, as described above, the difference between the length of the support member 100 in the X axis direction and the length between a pair of the restriction portions 202 aligned in the X axis direction is about 1 mm, the difference between the length of the support member 100 in the Y axis direction and a pair of the restriction portions 202 aligned in the Y axis direction is about 1 mm. In other words, the value c is 1 mm. Thus, the above expressions (1) and (3) are satisfied in the specific configuration of Embodiment 1. In addition, the value d is set in Embodiment 1 by adjusting the thickness of the support member 100 and the like such that the above expression (2) holds. Since the expressions (1) to (3) holds as above, the nozzle tips 300 are properly attached to the nozzles 400.

Note that the value (a−b) is 1.6 mm in the above expression (1) in case of the specific configuration, and the reason why the value c is set to 1 mm, which is much smaller than (a−b) is as follows. The tip rack 10 is fitted in the opening 618a of the frame 618 as described above. The opening 618a is configured such that a clearance of 0.5 mm remains between the outer peripheral surface 240 of the tip rack 10 and the opening 618a in the X axis direction and the Y axis direction at this time.

Thus, since the tip rack 10 moves within the clearance with the opening 618a and the support member 100 moves within the clearance with the restriction portion 202, the offset amount of the support member 100 relative to the nozzle 400 is 1 mm+0.5 mm=1.5 mm at maximum. As described above, the lengths of the parts are set such that even though the tip rack 10 and the support member 100 move at maximum, the offset amount of the support member 100 relative to the nozzle 400 does not exceed the value (a−b). Thus, according to the specific configuration, even if a clearance exists between the opening 618a of the frame 618 and the rack body 200, the nozzle tips 300 can be properly attached to the nozzles 400.

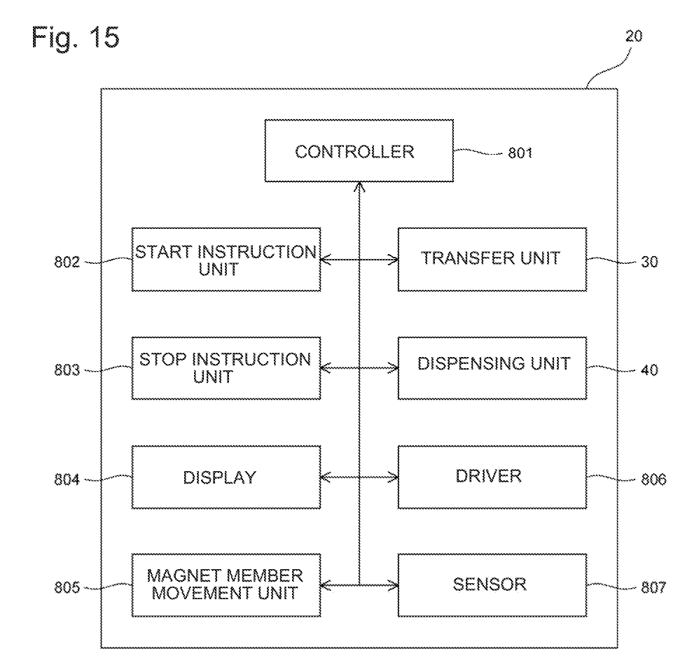

As illustrated in FIG. 15, the sample processing apparatus 20 includes the transfer unit 30, the dispensing unit 40, a controller 801, a start instruction unit 802, a stop instruction unit 803, a display 804, a magnet member movement unit 805, a driver 806, and a sensor 807.

The controller 801 includes, for example, an arithmetic processor and a storage unit. The arithmetic processor includes, for example, CPU or MPU. The storage unit include, for example, a flash memory and a hard disk drive. The controller 801 receives signals from units in the sample processing apparatus 20, and control the units of the sample processing apparatus 20.

The start instruction unit 802 is a button for starting processing of the sample processing apparatus 20. The stop instruction unit 803 is a button for stopping the processing of the sample processing apparatus 20. The display 804 includes, for example, an indicator or a liquid crystal panel. The start instruction unit 802, the stop instruction unit 803, and the display 804 are provided, for example, at the side surface portion or the upper surface portion of the sample processing apparatus 20. The magnet member movement unit 805 is a driver for moving a magnet to apply magnetic force through the opening 622b. The driver 806 includes other mechanisms arranged in the sample processing apparatus 20. The sensor 807 includes other sensors arranged in the sample processing apparatus 20.

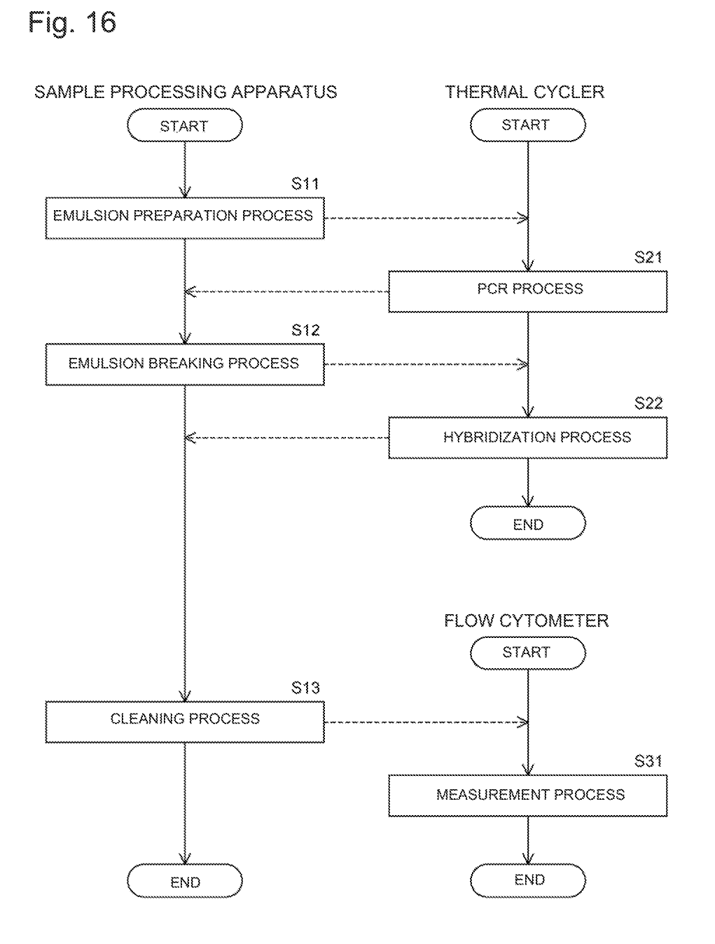

Next, descriptions are provided for a procedure of a gene test according to the BEAMing method using the sample processing apparatus 20, with reference to the FIG. 16. In Embodiment 1, a thermal cycler and a flow cytometer are used besides the sample processing apparatus 20.

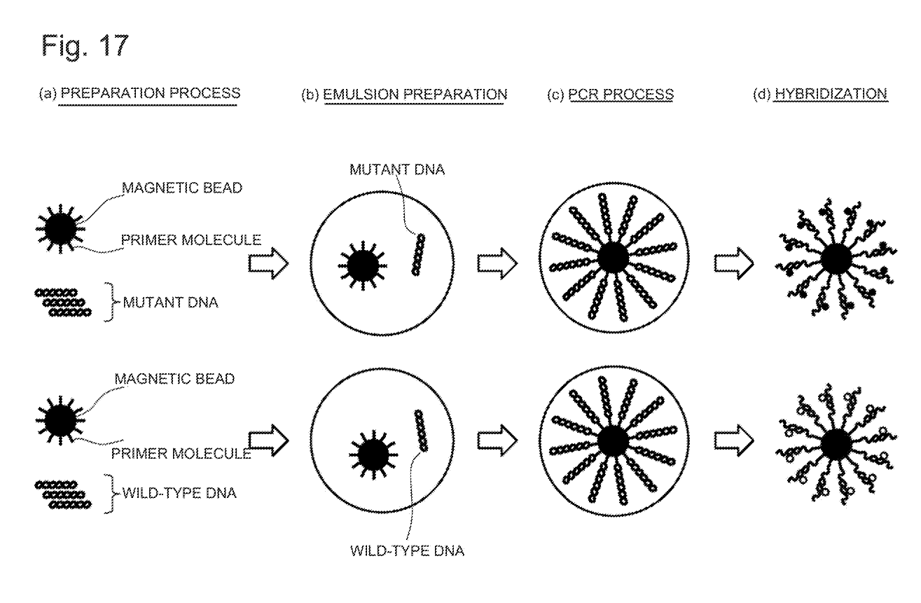

An operator first performs a preparation process for this method. Specifically, the operator extracts DNAs from blood samples of test subjects and performs PCR amplification, and dilutes samples including the amplified DNAs to the extent that an emulsion preparation process is possible. Then, the operator lets the wells 61a of the microplate 61 contain the samples including the amplified DNAs and magnetic beads to which primer molecules are bound as illustrated in FIG. 17A.

At step S11, the operator sets the prepared microplate 61 to the sample processing apparatus 20 and performs the emulsion preparation process. In the emulsion preparation process, the nozzle tips 300 are attached to the nozzles 400 and emulsion reagents are dispensed into the wells 61a. With this process, an oil phase is formed in an aqueous phase containing magnetic beads to which primer molecules are bound for amplification of target DNA molecules in the wells 61a, and thus water-in-oil (W/O type) emulsion to be supplied to PCR is prepared. As illustrated in FIG. 17B, for the liquid in the wells 61a, a large number of droplets each containing about one magnetic bead and about one target DNA are prepared.

At step S21, the operator sets the microplate 61 subjected to the emulsion preparation process to the thermal cycler and performs the PCR process. The thermal cycler performs a process repeating several times a cycle in which the temperature of the microplate 61 is changed to different temperatures. With this process, the target DNA molecule is amplified in each droplet of the W/O emulsion prepared in the emulsion preparation process. As illustrated in FIG. 17C, the target DNA molecules are amplified inside the droplet.

At step S12, the operator sets the microplate 61 subjected to the PCR process to the sample processing apparatus 20 again, and performs an emulsion breaking process to be described later. In the emulsion breaking process, the nozzle tips 300 are attached to the nozzles 400, and the first breaking reagent and the second breaking reagent are dispensed in the wells 61a. This process breaks in the wells 61a the W/O emulsion subjected to PCR, and recovers the magnetic beads from the droplets. In the emulsion breaking process, after the first breaking reagent and the second breaking reagent are dispensed, the reagent containing the label probes is dispensed in the wells 61a. With this process, the amplified target DNA molecules can be hybridized with the label probes.

At step S22, the operator sets the microplate 61 subjected to the emulsion breaking process to the thermal cycler again, and performs the hybridization process. The thermal cycler performs a process of changing the temperature of the microplate 61 to different temperatures. With this process, the mutant DNA molecules and the wild-type DNA molecules in the wells 61a are bound to the corresponding label probes, and the mutant DNA molecules and the wild-type DNA molecules are fluorescently labeled as illustrated in FIG. 17D.

At step S13, the operator sets the microplate 61 subjected to the hybridization process to the sample processing apparatus 20 again, and performs the cleaning process to be described later. In the cleaning process, the nozzle tips 300 are attached to the nozzles 400, and PBS which is a cleaning reagent is dispensed in the wells 61a. With the cleaning process, the BF separation occurs in the wells 61a, unreacted label probes are separated by suction from the magnetic beads. In other words, label probes not bound to magnetic beads are removed, leaving the magnetic beads to which the target DNA molecules and label probes are bound. Also, solvent is exchanged using PBS.

At step S31, the operator sets the microplate 61 subjected to the cleaning process to the flow cytometer and performs the measurement process. With this process, the magnetic beads cleaned in the cleaning process are counted by the flow cytometer, and the number of the magnetic beads bound to the label probe are counted.

Specifically, the flow cytometer sucks measurement specimen in the well 61a for each well 61a and flows it into a flow cell, and irradiates the measurement specimen flowing through the flow cell with laser light from a laser light source. At this time, fluorescence is generated from the label probes bound to mutant DNA molecules and the label probes bound to wild-type DNA molecules. The flow cytometer separates two types of fluorescence having different wavelengths generated by the label probes using a dichroic mirror and detects these two types of fluorescence with different detectors. Based on an output signal from each detector, the flow cytometer counts each of the number of the magnetic beads to which the mutant DNA molecules are bound and the number of the magnetic beads to which the wild-type DNA molecules are bound contained in the measurement specimens.

For each well 61a, the operator acquires the ratio of the number of magnetic beads to which the mutant DNA molecules are bound, to the sum of the number of magnetic beads to which the mutant DNA molecules are bound and the number of magnetic beads to which the wild-type DNA molecules are bound. With this process, the operator can know the mutation state of the target DNA molecules on the test subject from whom the target DNA molecules were obtained.

Note that the sample processing apparatus 20 may be configured to be able to perform the PCR process at step S21, the hybridization process at step S22, and the measurement process at step S31.

At steps S11 to S13, even if a positional offset occurs between the nozzle tips 300 and the nozzles 400, the nozzle tips 300 can be properly attached to the nozzles 400. Thus, it is possible to avoid a situation where a processing error occurs because the nozzle tip 300 is not properly attached to the nozzle 400, and the processing stops. Hence, samples can be properly processed.

### <Experiment on Frequency of Attachment Errors>

The inventor compares between the comparative example and Embodiment 1, the frequency at which the nozzle tip 300 is not properly attached to the nozzle 400, when performing processing of the sample processing apparatus 20 using a tip rack of a comparative example, and the tip rack 10 of the specific configuration of Embodiment 1.

The tip rack of the comparative example is configured to support 96 nozzle tips 300 in the same way as the tip rack 10 of Embodiment 1. In the tip rack of the comparative example, the support member is set to the rack body so as not to move relative to the rack body.

In the sample processing apparatus 20, eight nozzle tips 300 are attached to eight nozzles 400 at one movement for attaching the nozzle tips 300, as described with reference to FIGS. 12A and 12B. The sample processing apparatus 20 performs such an attachment movement for 14 tip racks per batch. Hence, per 1 batch, 12×14=168 times of attachment movements are performed. The same nozzle tips 300 are used both in the comparative example and Embodiment 1. The inventor judges by visual inspection or the like that an attachment error has occurred when a nozzle tip 300 is not attached to a nozzle 400 or liquid is not sucked.

Note that in the comparative example, when all the nozzle tips 300 on a tip rack are used, the tip rack is discarded and a new tip rack is set. In Embodiment 1, when all the nozzle tips 300 on a tip rack are used, new nozzle tips 300 are replenished to the tip rack 10.

In the comparative example, 29 batches of processing are performed, and an attachment error occurs in 3 of 29 batches. In other words, in the comparative example, attachment errors occur at a rate of 3/29=10.3%. In Embodiment 1, no error occurs in 20 batches of processing. From the above result, it is found that Embodiment 1 can avoid an attachment error and properly attach the nozzle tips 300 to the nozzles 400.

### Embodiment 2

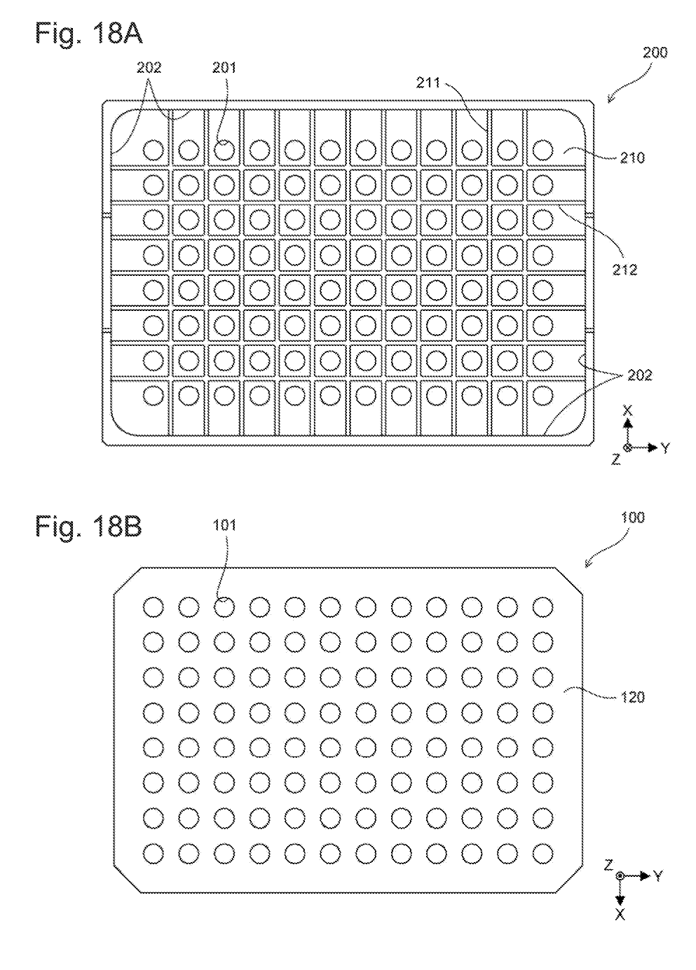

As illustrated in FIG. 18A, in Embodiment 2, walls 211 and 212 having a constant height and protruding in the Z axis negative direction from an upper surface 210 are formed in a lattice shape on the upper surface 210 of a rack body 200, compared to the rack body 200 illustrated in FIG. 4. Specifically, formed on the upper surface 210 are eleven walls 211 extending in the X axis direction and parallel to the XZ plane and seven walls 212 extending in the Y axis direction and parallel to the YZ plane. The upper ends of the walls 211 and 212 are positioned to the same plane parallel to the XY plane. The height of the walls 211 and 212 is the same as that of the walls 121 and 122 of the support member 100 illustrated in FIG. 5A.

As illustrated in FIG. 18B, a lower surface 120 of a support member 100 in Embodiment 2 is configured to be a surface parallel to the XY plane, compared to the support member 100 in FIG. 5A. The support member 100 is set to the rack body 200 by placing a lower surface 120 of the support member 100 illustrated in FIG. 18B onto the upper ends of the walls 211 and 212 of the rack body 200 illustrated in FIG. 18A. The other configurations in Embodiment 2 are the same as those in Embodiment 1.

Also in Embodiment 2, the distance between first holes 101 and second holes 201 can be increased by the walls 211 and 212. Thus, as in Embodiment 1, even if the nozzle tip 300 moves in the X axis direction and the Y axis direction along with the movement of the support member 100, it is possible to prevent the nozzle tip 300 from being inclined by the side surface of the nozzle tip 300 touching the inner side surface of the second hole 201. In addition, since the area where the support member 100 come into contact with the rack body 200 can be small, it is possible to move the support member 100 smoothly.

Note that the tip rack 10 may be configured by combining the rack body 200 illustrated in FIG. 18A and the support member 100 illustrated in FIG. 5A, or the tip rack 10 may be configured by combining the rack body 200 illustrated in FIG. 4 and the support member 100 illustrated in FIG. 18B. Alternatively, the walls 211 and 212 may be replaced with bosses and protrusions extending in the Z axis negative direction from the lower surface 120.

### Embodiment 3

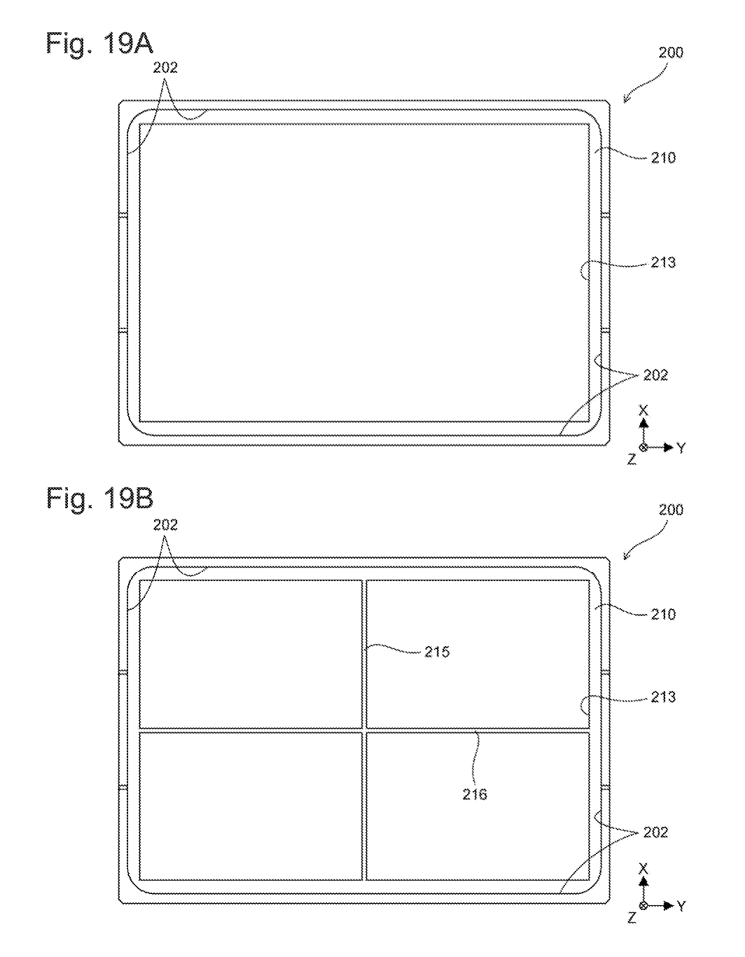

As illustrated in FIG. 19A, in Embodiment 3, an opening 213 large enough to accommodate the lower portions 320 of all the nozzle tips 300 supported by a support member 100 is formed at the center of an upper surface 210 of a rack body 200, compared to the rack body 200 illustrated in FIG. 4. The opening 213 may pass through from the upper surface 210 to a lower surface 220, or may have a surface lower than the upper surface 210 without passing through the lower surface 220. The other configurations in Embodiment 3 are the same as those in Embodiment 1.

In Embodiment 3, the support member 100 is inserted in a restriction portion 202 of the rack body 200 illustrated in FIG. 19A as in Embodiment 1. At this time, the outer periphery of the support member 100 is supported by the upper surface 210 of the rack body 200. With this configuration, the support member 100 is set to the rack body 200 as in Embodiment 1.

Note that when the rack body 200 is configured as illustrated in FIG. 19A, since the only outer circumferential portion of the support member 100 is supported by the upper surface 210, the support member 100 may be warped. When the warp of the support member 100 causes a problem, the rack body 200 illustrated in FIG. 19A may be configured as in FIG. 19B. The rack body 200 illustrated in FIG. 19B includes a bridge 215 extending in the X axis direction and passing through the center of the opening 213 and a bridge 216 extending in the Y axis direction and passing through the center of the opening 213. The bridges 215 and 216 are, for example, members having a specified thickness in the Z axis direction, and formed integrally with the rack body 200. The upper surfaces of the bridges 215 and 216 are positioned to the same surface as the upper surface 210. In this case, the bridges 215 and 216 support the lower end of the support member 100 and thus prevents the warp of the support member 100.

### Embodiment 4

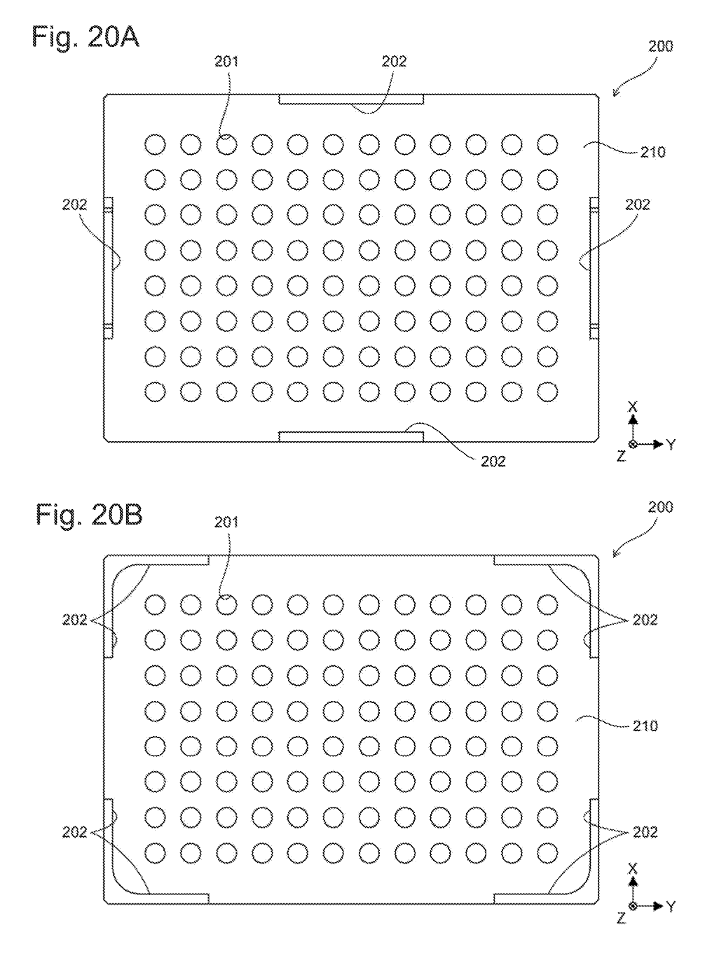

As illustrated in FIG. 20A, in Embodiment 4, a restriction portion 202 formed on an upper surface 210 is not formed over the entire outer periphery of the upper surface 210, but restriction portions 202 are formed at the end portions on the X axis positive side, the X axis negative side, the Y axis positive side, and the Y axis negative side of the upper surface 210, compared to the rack body 200 illustrated in FIG. 4. The other configurations in Embodiment 4 are the same as those in Embodiment 1. Also in this case, when a support member 100 is placed in the area surrounded by the four restriction portions 202, clearances 11 occur between the support member 100 and the restriction portions 202. Hence, the nozzle tips 300 can be properly attached to the nozzles 400 as in Embodiment 1.

Note that the rack body 200 illustrated in FIG. 20A may be configured as in FIG. 20B. The rack body 200 as illustrated in FIG. 20B has restriction portions 202 provided at the four corners of the upper surface 210. Also in this case, when the support member 100 is placed on the area surrounded by the restriction portions 202, the clearance 11 occurs between the support member 100 and the restriction portions 202. Hence, the nozzle tips 300 can be properly attached to the nozzles 400 as in Embodiment 1.

The invention includes other embodiments in addition to the above-described embodiments without departing from the spirit of the invention. The embodiments are to be considered in all respects as illustrative, and not restrictive. The scope of the invention is indicated by the appended claims rather than by the foregoing description. Hence, all configurations including the meaning and range within equivalent arrangements of the claims are intended to be embraced in the invention.

1. A tip rack for detachably supporting a nozzle tip to be attached to a distal end portion of a nozzle, comprising:
a support member that is provided with first holes each to support the nozzle tip; and
a rack body that supports the support member such that the support member is movable in a direction intersecting with center axes of the first holes, and that is provided with second holes corresponding to the first holes, the second holes each having a depth enough to accommodate a lower portion of the nozzle tip supported by the corresponding first hole, the lower portion including a distal end of the nozzle tip.

2. The tip rack according to claim 1, wherein
the support member is attachable to and detachable from the rack body.

3. The tip rack according to claim 1, wherein
the rack body includes a restriction portion that faces an outer periphery of the support member with a specified clearance, and that allows the support member to move within the clearance in the direction intersecting with the center axes of the first holes.

4. The tip rack according to claim 1, wherein
a movement range of the support member is set larger than or equal to a difference between a diameter of an opening at an upper end of the nozzle tip and a maximum width of the distal end portion of the nozzle to be inserted into the opening.

5. The tip rack according to claim 1, wherein
a diameter of each of the second holes is set such that a side surface of the nozzle tip supported by the corresponding first hole does not touch an inner side surface of the second hole when the support member moves in a movement range of the support member relative to the rack body.

6. The tip rack according to claim 1, wherein
a wall in a lattice shape with a constant height is formed on a lower surface of the support member, and a lower end of the wall is placed on a support surface of the rack body.

7. The tip rack according to claim 6, wherein
the wall is formed such that areas surrounded by the wall are arrayed in a matrix shape, and
the first holes are formed in the areas, respectively.

8. The tip rack according to claim 1, wherein
the first holes are formed in the support member to be arrayed in a matrix shape.

9. The tip rack according to claim 1, comprising
a contact portion that contacts the support member to restrict movement of the support member such that the support member does not get apart from the rack body in a direction parallel to the center axes of the first holes.

10. The tip rack according to claim 9, wherein
the contact portion is a protrusion protruding from the rack body toward the support member.

11. The tip rack according to claim 1, wherein
the rack body includes a base provided with the second holes, and
the base excluding the second holes is fully made of a material of the rack body.

12. The tip rack according to claim 11, wherein
a specific gravity of the material of the rack body is larger than a specific gravity of the support member.

13. The tip rack according to claim 1, wherein
the support member includes a temporary fixing portion to temporarily fix a second support member to an upper surface of the support member in the case where the support member supports the nozzle tip supported by the second support member.

14. The tip rack according to claim 1, wherein
a diameter of the second holes is set smaller than or equal to a diameter of the first holes.

15. The tip rack according to claim 1, wherein
an outer peripheral surface of the rack body is provided with a depression depressed inward of the rack body.

16. The tip rack according to claim 1, wherein
an outer peripheral surface of the rack body is provided with an inclined surface extending gradually outward of the rack body while extending upward.

17. A tip rack for detachably supporting a nozzle tip to be attached to a distal end portion of a nozzle, comprising:
a support member that is provided with a hole to support the nozzle tip; and
a rack body that supports the support member such that the support member is movable in a direction intersecting with a center axis of the hole, wherein
a movement range of the support member relative to the rack body is set larger than or equal to a difference between a diameter of an opening at an upper end of the nozzle tip and a maximum width of the distal end portion of the nozzle to be inserted into the opening.

18. The tip rack according to claim 17, wherein
the movement range of the support member is set smaller than or equal to a difference between the diameter of the opening at the upper end of the nozzle tip and a minimum width of the distal end portion of the nozzle to be inserted into the opening.

19. A sample processing apparatus comprising:
the tip rack according to claim 1;
a frame into which the rack body is fitted; and
a nozzle to which the nozzle tip is attached, wherein
the sample processing apparatus processes a sample using the nozzle tip attached to the nozzle.

20. A rack body for supporting a support member provided with first holes each to detachably support a nozzle tip to be attached to a distal end portion of a nozzle, wherein
the rack body supports the support member such that the support member is movable in a direction intersecting with center axes of the first holes, and has second holes corresponding to the first holes, the second holes each having a depth enough to accommodate a lower portion of the nozzle tip supported by the corresponding first hole, the lower portion including a distal end of the nozzle tip.

21. A method of attaching a nozzle tip, comprising:
moving a nozzle to above a rack body that supports a support member with a first hole to support the nozzle tip such that the support member is movable with respect to the rack body in a direction intersecting with a center axis of the first hole;
inserting the nozzle into an opening at an upper end of the nozzle tip supported by the first hole, by moving down the nozzle to the support member supported by the rack body; and
attaching the nozzle tip to the nozzle by further inserting the nozzle into the nozzle tip which is adjusted in position by movement of the support member in the direction intersecting with the center axis of the first hole.
